(19) United States
(12) Patent Application Publication
(10) Pub. No.: US 2023/0059705 A1
(43) Pub. Date: Feb. 23, 2023

(54) NITRIFICATION INHIBITOR FUNGICIDE COMPOSITION AND USE THEREOF

(71) Applicant: Verdesian Life Sciences U.S., LLC, Cary, NC (US)

(72) Inventors: Gary ORR, Pittsboro, NC (US); Kuide QIN, Chapel Hill, NC (US)

(21) Appl. No.: 17/788,431

(22) PCT Filed: Dec. 15, 2020
(86) PCT No.: PCT/US2020/065015

§ 371 Date: Jun. 23, 2022

Related U.S. Application Data
(60) Provisional application No. 62/952,902, filed on Dec. 23, 2019.

(51) Int. Cl. A01N 43/40; A01N 37/04; A01N 25/10; A01N 25/02; A01N 47/26; A01P 3/00

(52) U.S. Cl. CPC A01N 43/40; A01N 37/04; A01N 25/10; A01N 25/02; A01N 47/26; A01P 3/00

(57) ABSTRACT

The present invention is directed to compositions containing a fungicide, a nitrification inhibitor, and a polyanion and finding particular utility in agricultural uses, e.g., directly applied to soil, or in combination with fertilizers to increase nutrient uptake and to inhibit nitrification and urease hydrolysis. More particularly, the subject matter is directed to compositions including a fungicide selected from amide-based fungicides, dithiocarbamate-based fungicides, oxazole-containing fungicides, phosphoric acid-derived fungicides, and a combination thereof; a nitrification inhibitor selected from S-containing compounds, cyano-containing compounds, N-heterocyclic-containing compounds, and a combination thereof, and a polyanion selected from a non-polymeric polyanion, a polymeric polyanion, and a combination thereof. Other uses of these compositions are also disclosed.

### FIELD

The present invention relates to compositions that can be employed in agricultural applications such as increasing nutrient uptake and inhibiting nitrification comprising a fungicide and a nitrification inhibitor present in synergistically effective amounts, further comprising a polyanion.

### BACKGROUND

Nitrogen (N) fertilizer added to the soil is readily transformed through a number of biological and chemical processes, including nitrification, leaching, and evaporation. Typically, the nitrogen fertilizer is applied to the soil either in liquid or in solid form. However, maintaining adequate levels of concentration of nitrogen in the soil over time is difficult due to the solubility of nitrogen and nitrogen-containing compounds (such as urea) in water. Rainwater in contact with the soil can flush nitrogen or nitrogen-containing compounds into surrounding waterways. Not only does a significant percentage of nitrogen fertilizer flow to aquatic systems by the runoff of ammonium (NH₄⁺) and nitrate (NO₃⁻) but also the atmosphere is affected by gaseous N emissions. As a result, the level of nitrogen available for uptake by the targeted plant is reduced, requiring the addition of more nitrogen-rich fertilizer to compensate for the loss of agriculturally active nitrogen available to the plants.

One transformation responsible for the reduction of available nitrogen to the targeted plant is nitrification. Nitrification is a chemical process by which the nitrogen fertilizer is transformed, e.g., bacteria in the soil metabolizes the ammonium form of nitrogen to nitrite and nitrate forms (which are more susceptible to nitrogen loss through leaching or volatilization via denitrification). One method of controlling the rate of nitrification is the employment of nitrogen nutrient use efficiency enhancing compounds: the so-called nitrification inhibitors. These inhibitors are able to inhibit nitrogen loss by depressing the Nitrosomonas bacteria that catalyzes the microbial oxidation of ammonia (NH₄⁺) to nitrite (NO₂⁻). The microbial activity can be successfully suppressed by these compounds for a certain period (several weeks or months) depending on soil moisture and/or soil type. For example, nitrification inhibitors generally are more effective in sandy soils or soil low in organic matter and/or when exposed to low temperatures.

Due to the various factors controlling both the rate of nitrification and the activity of the inhibitor, the number of applications of the nitrification inhibitor can vary. In regions where the soil type and/or climate zone requires multiple applications of the nitrification inhibitor resistance against these single active agents has begun to emerge. The overuse and/or continuous use of these single active agents results in a decrease in inhibitory efficacy against living nitrifying soil organisms such as bacteria and arachaea.

Thus, there is a constant need to improve the current nitrification inhibitor containing compositions. In particular, it would be highly desirable to develop nitrification inhibitor containing compositions that are able to increase the life expectancy of nitrogen in the soil to assure more consistent levels of nitrogen during the growing season while also decreasing the number of times the fertilizer and/or nitrification inhibitor is applied to the soil. Decreasing the number of applications of fertilizer and/or nitrification inhibitor will not only lower the overall cost to the agriculture industry, while at the same time limiting the amount of nitrogen carried into the waterways, but will also lower the occurrence of resistance towards single active nitrification inhibitors.

### BRIEF SUMMARY

In one aspect, the subject matter described herein is directed to compositions including a fungicide selected from phenyl amide-based fungicides, dithiocarbamate-based fungicides, oxazole-containing fungicides, phosphoric acid-derived fungicides, and a combination thereof; a nitrification inhibitor selected from an S-containing compound, a cyano-containing compound, an N-heterocyclic-containing compound, and a combination thereof; and a polyanion. In some embodiments, the fungicide is selected from mancozeb, metalaxyl, thiram, zineb and a combination thereof. In some embodiments, the nitrification inhibitor is selected from nitrapyrin, dicyandiamide (DCD), 3,4-Dimethylpyrazole phosphate (DMPP), pronitridine, and a combination thereof. In some embodiments, the polyanion is selected from a non-polymeric polyanion, a polyanionic polymer, and a combination thereof.

In one aspect, the subject matter described herein is directed to an agricultural product comprising the composition as described herein.

In one aspect, the subject matter described herein is directed to methods of reducing nitrification in a soil, comprising of contacting an effective amount of a composition of the invention or an agricultural composition of the invention with the soil. The effective amount would be amounts of each component (i.e., the fungicide and nitrification inhibitor) that would elicit a synergistic effect, such as but not limited to synergistic nitrification inhibitory activity compared to nitrification inhibitory activity for each component on their own.

These and other aspects are fully described below.

### BRIEF DESCRIPTION OF THE DRAWINGS

FIG. 1 shows a bar chart of the generation of nitrite from N. europaea (cells at 0.25 mg/mL total protein) in the presence and/or absence of fungicide thiram, nitrification inhibitor formulation 2 (also referred to as form.2), and a mixture of thiram/formulation 2;

FIG. 2 shows a bar chart of the percentage of control of nitrification inhibition of N. europaea in the presence and/or absence of fungicide thiram, nitrification inhibitor formulation 2, and a mixture of thiram/formulation 2;

FIG. 3 shows a bar chart of the percentage of control of nitrification inhibition of N. europaea in the presence and/or absence of fungicide thiram, nitrification inhibitor formulation 3 (also referred to as form.3), and a mixture of thiram/formulation 3;

FIG. 4 shows a bar chart of the percentage of control of nitrification inhibition of N. europaea in the presence and/or absence of fungicide thiram, nitrification inhibitor formulation 4 (also referred to as form.4), and a mixture of thiram/formulation 4;

FIG. 5 shows a bar chart of the generation of nitrite from N. europaea (cells at 0.25 mg/mL total protein) in the presence and/or absence of fungicide thiram, nitrification inhibitor formulation 3, and a mixture of thiram/formulation 3;

FIG. 6 shows a bar chart of the generation of nitrite from N. europaea (cells at 0.25 mg/mL total protein) in the presence and/or absence of fungicide thiram, nitrification inhibitor formulation 4, and a mixture of thiram/formulation 4;

FIG. 7 shows a bar chart of the generation of nitrite from N. europaea (cells at 0.5 mg/mL total protein) in the presence and/or absence of a formulation containing nitrapyrin alone or in combination with fungicide thiram;

FIG. 8 shows a bar chart of the generation of nitrite from N. europaea (cells at 0.5 mg/mL total protein) in the presence and/or absence of fungicide thiram, nitrification inhibitor formulation 2, and a mixture of thiram/formulation 2;

FIG. 9 shows a bar chart of the generation of nitrite from N. europaea (cells at 0.5 mg/mL total protein) in the presence and/or absence of fungicide thiram, nitrification inhibitor formulation 3, and a mixture of thiram/formulation 3;

FIG. 10 shows a bar chart of the generation of nitrite from N. europaea (cells at 0.5 mg/mL total protein) in the presence and/or absence of fungicide thiram, nitrification inhibitor formulation 4, and a mixture of thiram/formulation 4;

FIG. 11 shows a general scheme for the determination of N. europaea oxygenation consumption.

FIG. 12 shows a bar chart of the oxygen consumption of N. europaea (cells at 0.5 mg/mL total protein) in the presence and absence of inhibitors thiram, nitrapyrin, and nitrification inhibitor formulation 2, 3, and 4;

FIG. 13 shows a bar chart of the oxygen consumption of N. europaea (cells at 0.25 mg/mL total protein) in the presence and absence of inhibitors thiram, nitrapyrin, and nitrification inhibitor formulation 2, 3, and 4;

FIG. 14 shows a bar chart of the oxygen consumption of N. europaea (cells at 0.5 mg/mL total protein) in the presence and absence of thiram, nitrapyrin, nitrification inhibitor formulation 2, and a mixture of thiram/formulation 2;

FIG. 15 shows a bar chart of the oxygen consumption of N. europaea (cells at 0.25 mg/mL total protein) in the presence and absence of thiram, nitrapyrin, nitrification inhibitor formulation 2, and a mixture of thiram/formulation 2;

FIG. 16 shows a bar chart of the oxygen consumption of N. europaea (cells at 0.5 mg/mL total protein) in the presence and absence of thiram, nitrapyrin, nitrification inhibitor formulation 3, and a mixture of thiram/formulation 3;

FIG. 17 shows a bar chart of the oxygen consumption of N. europaea (cells at 0.25 mg/mL total protein) in the presence and absence of thiram, nitrapyrin, nitrification inhibitor formulation 3, and a mixture of thiram/formulation 3;

FIG. 18 shows a bar chart of the oxygen consumption of N. europaea (cells at 0.5 mg/mL total protein) in the presence and absence of thiram, nitrapyrin, nitrification inhibitor formulation 4, and a mixture of thiram/formulation 4; and

FIG. 19 shows a bar chart of the oxygen consumption of N. europaea (cells at 0.25 mg/mL total protein) in the presence and absence of thiram, nitrapyrin, nitrification inhibitor formulation 4, and a mixture of thiram/formulation 4.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

It has been noted that continuous use of currently single active ingredient nitrification inhibitors results in a decrease of inhibitor efficacy against living nitrifying soil organisms such as bacteria and arachaea. Thus, the current invention relates to a dual use active ingredient nitrification inhibitor to address the increasing resistance observed in current single use active ingredient nitrification inhibitors.

In particular, the current invention relates to compositions comprising a fungicide (e.g., phenyl amide-based fungicides, dithiocarbamate-based fungicides, and/or phosphoric acid-derived fungicides) and a nitrification inhibitor (e.g., S-containing compounds, cyano-containing compounds, and/or N-heterocyclic-containing compounds) for inhibiting nitrification in the soil and to increase nutrient uptake in the presence of a polyanion.

Not to be bound by theory, but it is believed that by combining a fungicide and nitrification inhibitor as disclosed herein a synergistic effect is produced. This may be due to the alternate modes of action exhibited by these two different compound classes, particularly when attacking the nitrifying organisms present in the soil. The presence of a fungicide in the nitrification inhibitor composition increases the overall efficacy of the resulting product mixture (fungicide/nitrification inhibitor) by inhibiting nitrification in additional organisms that are not typically affected by the single active use ingredient nitrification inhibitor. Thus, the resulting product mixture not only exhibits a broader biological inhibitory spectrum with respect to modulating a broader population of organisms in the soil but also promotes less resistance as the product mixture exhibits different inhibitory mechanisms and/or modes of action than a single use inhibitor which would suggest fewer applications required to maintain adequate nitrogen in the soil.

### I. DEFINITIONS

As used herein, “nitrification inhibitor” refers to a property of a compound to inhibit oxidation of ammonia to nitrite/nitrate.

As used herein, “fungicide” refers to biocidal chemical compounds used to kill parasitic fungi or their spores. Fungicides disclosed herein can be, but are not limited to, contact, translaminar or systemic fungicides. Contact fungicides are not taken up into the plant tissue and protect only the plant where the spray is deposited. Translaminar fungicides redistribute the fungicide from the upper, sprayed leaf surface to the lower, unsprayed surface. Systemic fungicides are taken up and redistributed through the xylem vessels.

The term “synergistic effect” is understood to be defined according to Colby's formula (Colby, S. R., “Calculating synergistic and antagonistic responses of herbicide combinations,” Weeds, 15, pp. 20-22, 1967).

As used herein, the term “synergistically effective” refers to an effect that is obtained from two different chemicals (e.g., a fungicide and a nitrification inhibitor) that is greater than the sum of their individual effects at the same doses.

As used herein, the term “effective amount” refers to an amount of a mixture of components (i.e., fungicide/nitrification inhibitor) and/or the amount of each component in the mixture (i.e., fungicide or nitrification inhibitor), which is sufficient for achieving nitrification inhibition as described below. More exemplary information about amounts, ways of application and suitable ratios to be used is given below. A skilled artisan is well aware of the fact that such an amount can vary in a broad range and is dependent on various factors, e.g., weather, target species, locus, mode of application, soil type, treated cultivated plant or material and the climatic conditions.

Throughout this specification and the claims, the words “comprise,” “comprises,” and “comprising” are used in a nonexclusive sense, except where the context requires otherwise, and are synonymous with “including,” “containing,” or “characterized by,” meaning that it is open-ended and does not exclude additional, unrecited elements or method steps.

As used herein, the transitional phrase “consisting essentially of” limits the scope of a claim to the specified materials or steps “and those that do not materially affect the basic and novel characteristic(s)” of the claimed invention.

As used therein, the transitional phrase “consisting of” excludes any element, step, or ingredient not specified in the claim.

As used herein, the term “about,” when referring to a value, is meant to encompass variations of in some embodiments ±5%, in some embodiments ±2%, in some embodiments ±1%, in some embodiments ±0.5%, and in some embodiments ±0.1% from the specified amount, as such variations are appropriate to perform the disclosed methods or employ the disclosed compositions.

As used herein, the term “alkyl group” refers to a saturated hydrocarbon radical containing 1 to 10, 1 to 6, 1 to 4, or 5 to 10 carbons. An alkyl group is structurally similar to a noncyclic alkane compound modified by the removal of one hydrogen from the noncyclic alkane and the substitution therefor of a non-hydrogen group or radical. Alkyl group radicals can be branched or unbranched. Lower alkyl group radicals have 1 to 4 carbon atoms. Higher alkyl group radicals have 5 to 10 carbon atoms. Examples of alkyl, lower alkyl, and higher alkyl group radicals include, but are not limited to, methyl, ethyl, n-propyl, iso-propyl, n-butyl, sec butyl, t butyl, amyl, t amyl, n-pentyl, n-hexyl, i-octyl and like radicals.

As used herein, the term “substituted” refers to a moiety (such as an alkyl group) wherein the moiety is bonded to one or more additional organic or inorganic substituent radicals. In some embodiments, the substituted moiety comprises 1, 2, 3, 4, or 5 additional substituent groups or radicals. Suitable organic and inorganic substituent radicals include, but are not limited to, hydroxyl, cycloalkyl, aryl, substituted aryl, heteroaryl, heterocyclic ring, substituted heterocyclic ring, amino, mono-substituted amino, di-substituted amino, acyloxy, nitro, cyano, carboxy, carboalkoxy, alkyl carboxamide, substituted alkyl carboxamide, dialkyl carboxamide, substituted dialkyl carboxamide, alkylsulfonyl, alkylsulfinyl, thioalkyl, alkoxy, substituted alkoxy or haloalkoxy radicals, wherein the terms are defined herein. Unless otherwise indicated herein, the organic substituents can comprise from 1 to 4 or from 5 to 8 carbon atoms. When a substituted moiety is bonded thereon with more than one substituent radical, then the substituent radicals may be the same or different.

As used herein, the term “unsubstituted” refers to a moiety (such as an alkyl group) that is not bonded to one or more additional organic or inorganic substituent radical as described above, meaning that such a moiety is only substituted with hydrogens.

As used herein, the term “aromatic moiety” refers to aromatic mono- or bicyclic ring systems having 6 to 10 atoms. Examples of such aromatic moieties include phenyl and/or napthyl moieties. Additional examples also include aromatic mono- or bicyclic ring systems that contain one or more heteroatoms such as S, N and/or O, which are referred to as heteroaromatics. Examples of heteroaromatics include pyridine, oxazole, thiophene, quinazoline, quinolone, etc.

As used herein, the term “soil” is to be understood as a natural body comprised of living (e.g., microorganisms (such as bacteria and fungi), animals and plants) and non-living matter (e.g., minerals and organic matter (e.g., organic compounds in varying degrees of decomposition), liquid, and gases) that occurs on the land surface, and is characterized by soil horizons that are distinguishable from the initial material as a result of various physical, chemical, biological, and anthropogenic processes. From an agricultural point of view, soils are predominantly regarded as the anchor and primary nutrient base for plants (plant habitat).

As used herein, the term “fertilizer” is to be understood as chemical compounds applied to promote plant and fruit growth. Fertilizers are typically applied either through the soil (for uptake by plant roots) or by foliar feeding (for uptake through leaves). The term “fertilizer” can be subdivided into two major categories: a) organic fertilizers (composed of decayed plant/animal matter) and b) inorganic fertilizers (composed of chemicals and minerals).

Organic fertilizers include manure, slurry, worm castings, peat, seaweed, sewage, and guano. Green manure crops are also regularly grown to add nutrients (especially nitrogen) to the soil. Manufactured organic fertilizers include compost, blood meal, bone meal, and seaweed extracts. Further examples are enzymatically digested proteins, fish meal, and feather meal. The decomposing crop residue from prior years is another source of fertility. In addition, naturally occurring minerals such as mine rock phosphate, sulfate of potash, and limestone are also considered inorganic fertilizers. Inorganic fertilizers are usually manufactured through chemical processes (such as the Haber-Bosch process), also using naturally occurring deposits, while chemically altering them (e.g., concentrated triple superphosphate). Naturally occurring inorganic fertilizers include Chilean sodium nitrate, mine rock phosphate, and limestone.

As used herein, the term “manure” is organic matter used as organic fertilizer in agriculture. Depending on its structure, manure can be divided into liquid manure, semi-liquid manure, stable or solid manure, and straw manure. Depending on its origin, manure can be divided into manure derived from animals or plants. Common forms of animal manure include feces, urine, farm slurry (liquid manure), or farmyard manure (FYM), whereas FYM also contains a certain amount of plant material (typically straw), which may have been used as bedding for animals. Animals from which manure can be used comprise horses, cattle, pigs, sheep, chickens, turkeys, rabbits, and guano from seabirds and bats. The application rates of animal manure when used as fertilizer highly depends on the origin (type of animals). Plant manures may derive from any kind of plant, whereas the plant may also be grown explicitly for the purpose of plowing them in (e.g., leguminous plants), thus improving the structure and fertility of the soil. Furthermore, plant matter used as manure may include the contents of the rumens of slaughtered ruminants, spent hops (left over from brewing beer), or seaweed.

As used herein, the term “seed” comprises seed of all types, such as, for example, corns, seeds, fruits, tubers, seedlings, and similar forms. The seed used can be seed of the useful plants mentioned above, but also the seed of transgenic plants or plants obtained by customary breeding methods.

As used herein, the term “complex” or “complex substance” refers to chelates, coordination complexes, and salts of nitrification inhibitors (e.g., nitrapyrin), wherein the nitrification inhibitor associates with functional groups of polyanion(s) in a covalent (i.e., bond forming) or noncovalent (i.e., ionic) manner. In a complex, a central moiety or ion (e.g., nitrapyrin) associates with a surrounding array of bound molecules or ions known as ligands or complexing agents (e.g., polyanion(s)). The central moiety binds to or associates with several donor atoms of the ligand, wherein the donor atoms can be the same type of atom or can be a different type of atom. Ligands or complexing agents bound to the central moiety through several of the ligand's donor atoms forming multiple bonds (i.e., 2, 3, 4 or even 6 bonds) are referred to as polydentate ligands. Complexes with polydentate ligands are called chelates. Typically, complexes of central moieties with ligands are increasingly more soluble than the central moiety by itself because the ligand(s) that surround(s) the central moiety do(es) not dissociate from the central moiety once in solution and solvate(s) the central moiety thereby promoting its solubility.

As used herein, the term “salt” refers to chemical compounds consisting of an assembly of cations and anions. Salts are composed of related numbers of cations (positively charged ions) and anions (negative ions) so that the product is electrically neutral (without a net charge).

Many ionic compounds exhibit significant solubility in water or other polar solvents. The solubility is dependent on how well each ion interacts with the solvent.

As used herein, the term “reduce volatility” and the like refer to the volatility of the nitrification-polyanion complex (e.g., nitrapyrin complex) as compared to that of the uncomplexed nitrification inhibitor (e.g., nitrapyrin free base). The reduction in volatility can be quantified as described elsewhere herein.

As used herein, the term “organic solvent” refers to a non-aqueous solvent that solvates the nitrification inhibitor and/or fungicide, and/or polyanion, and/or nitrification-polyanion complex (e.g., nitrapyrin complex) to the degree as described elsewhere herein. As used herein, the term “non-aqueous” refers to a solvent that contains no more than 0.2% by weight water based on the total weight of the solvent.

As used herein, the term “inhibit urease” and the like refer to the inhibition of the activity of the urease enzyme.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller ranges is also encompassed, subject to any specifically excluded limit in the stated range. Where the stated range includes one or both of the limits, ranges excluding either or both of those included limits are also included.

Additional definitions may follow below.

### II. COMPOSITIONS

The current invention relates to a composition comprising/consisting essentially/consisting of a fungicide selected from amide-based fungicides, dithiocarbamate-based fungicides, oxazole-containing fungicides, phosphoric acid-derived fungicides, and a combination thereof; a nitrification inhibitor selected from S-containing compounds, cyano-containing compounds, N-heterocyclic-containing compounds, and a combination thereof; and a polyanion. In some embodiments, the fungicide present in the composition is only a single fungicide. In some embodiments, the fungicide present in the composition is a combination of at least two or more fungicides. In some embodiments, the nitrification inhibitor present in the composition is only a single nitrification inhibitor. In some embodiments, the nitrification inhibitor present in the composition is a combination of at least two or more nitrification inhibitors. In some embodiments, the polyanion present in the composition is non-polymeric polyanion, a polyanionic polymer, or a combination thereof.

The amount of the fungicide, nitrification inhibitor, and polyanion present in the composition can vary. In some embodiments, the fungicide is present in an amount of from about 0.01% to about 99.9% w/w, from about 0.01% to about 90% w/w, from about 0.01% to about 45% w/w, from about 0.5% to about 75% w/w, from about 0.5% to about 30% w/w, from about 0.5% to about 20% w/w, from about 1% to about 50% w/w, from about 1% to about 30% w/w, from about 1% to about 20% w/w, from about 1% to about 10% w/w, from about 1% to about 5% w/w, from about 0.5% to about 5% w/w (or less than about 95% w/w, about 90% w/w, about 80% w/w, about 70% w/w, about 60% w/w, about 50% w/w, about 40% w/w, about 30% w/w, about 20% w/w, about 10% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, about 0.2% w/w, or less than about 0.1% w/w) based on the total weight of the composition. In some embodiments, the fungicide is present in an amount from about 0.01% to about 10% w/w, from about 0.01% to about 9% w/w, from about 0.01% to about 8% w/w from about 0.01% to about 7% w/w, from about 0.01% to about 6% w/w, from about 0.01% to about 5% w/w, from about 0.01% to about 4% w/w, from about 0.01% to about 3% w/w, from about 0.01% to about 2% w/w, from about 0.1% to about 2% w/w, from about 0.5% to about 2% w/w from, about 0.5% to about 1.5% w/w, or from about 0.75% to about 1.25% w/w based on the total weight of the composition.

In some embodiments, the nitrification inhibitor is present in an amount of from about 0.01% to about 99.9% w/w, from about 0.01% to about 30% w/w, from about 1% to about 95% w/w, from about 5% to about 90% w/w, from about 10% to about 85% w/w, from about 15% to about 50% w/w (or at least about 1% w/w, about 5% w/w, about 10% w/w, about 15% w/w, about 20% w/w, about 25% w/w, about 30% w/w, about 35% w/w, about 40% w/w, about 45% w/w, about 50% w/w, about 55% w/w, about 60% w/w, about 65% w/w, about 70% w/w, about 75% w/w, about 80% w/w, about 85% w/w, about 90% w/w, about 95% w/w, or at least about 98% w/w) based on the total weight of the composition. In some embodiments, the nitrification inhibitor is present in an amount of from about 0.01% to about 30% w/w, from about 5% to about 30% w/w, from about 10% to about 30% w/w, from about 15% to about 30% w/w, from about 20% to about 30% w/w, from about 10% w/w to about 20% w/w, from about 21% to about 30% w/w, from about 22% to about 30% w/w, from about 23% to about 30% w/w, from about 24% to about 30% w/w, from about 25% to about 30% w/w, from about 26% to about 30% w/w, from about 27% to about 30%, from about 28% to about 30%, or from about 29% to about 30% w/w based on the total weight of the composition.

In some embodiments, the nitrification inhibitor and fungicide are present in a combined total amount of from about 0.02% to about 99.8% w/w, from about 1% to about 95% w/w, from about 5% to about 90% w/w, from about 10% to about 85% w/w, from about 15% to about 50% w/w (or at least about 1% w/w, about 5% w/w, about 10% w/w, about 15% w/w, about 20% w/w, about 25% w/w, about 30% w/w, about 35% w/w, about 40% w/w, about 45% w/w, about 50% w/w, about 55% w/w, about 60% w/w, about 65% w/w, about 70% w/w, about 75% w/w, about 80% w/w, about 85% w/w about 90% w/w, about 95% w/w, or at least about 98% w/w) based on the total weight of the composition.

In some embodiments, the fungicide(s) and the nitrification inhibitor(s) are present in a weight ratio of from about 1:1000 to about 1000:1, from about 1:900 to about 900:1, from about 1:800 to about 800:1, from about 1:700 to about 700:1, from about 1:600 to about 600:1, from about 1:500 to about 500:1, from about 1:400 to about 400:1, from about 1:300 to about 300:1, from about 1:200 to about 200:1, from about 1:100 to about 100:1, from about 1:99 to about 99:1, from about 1:75 to about 75:1, from about 1:50 to about 50:1, from about 1:35 to about 35:1, from about 1:30 to about 30:1, from about 1:24 to about 24:1, from about 1:25 to about 25:1, from about 1:20 to about 20:1, from about 1:15 to about 15:1, from about 1:10 to about 10:1, from about 1:5 to about 5:1, from about 1:2 to about 2:1, or about 1:1.

In some embodiments, the fungicide and nitrification inhibitor are present in synergistically effective amounts. Such an amount provides inhibition of nitrification that is greater than the sum of the individual inhibitory properties of the fungicide and nitrification inhibitor toward nitrification. Such an observation was surprising and unexpected that two different classes of compounds such as a fungicide and nitrification inhibitor would exhibit such synergism towards inhibiting nitrification. In some embodiments, the amount of fungicide is less than the amount of nitrification inhibitor present in the composition. In some embodiments, the amount of fungicide is more than the amount of nitrification inhibitor present in the composition. In some embodiments, the amount of fungicide and nitrification inhibitor present in the composition is the same.

In some embodiments, the polyanion is present in an amount of from about 0.01% w/w to about 30% w/w, 0.01% w/w to about 15% w/w, from about 0.1% to about 25% w/w, from about 1% to about 20% w/w, from about 5% to about 12% w/w, from about 8% to about 12%, from about 5% to about 12% w/w, from about 7% to about 11% w/w, from about 8% to about 12% w/w, from about 5% to about 9% w/w, or from about 10% to about 12% w/w based on the total weight of the composition. In some embodiments, the polyanion is present in an amount of from about 0.01% to about 15% w/w, from about 0.1% to about 15% w/w, from about 0.1% to about 12% w/w from about 1% to about 12% w/w from about 3% to about 12% w/w, from about 7% to about 12 w/w, from about 5% to about 9% w/w, or from about 9% to about 12% w/w based on the total weight of the composition. In some embodiments, the polyanion forms a complex with the nitrification inhibitor. In some embodiments, the amount of polyanion present in the composition is less than the amount of nitrification inhibitor present in the formulation. In some embodiments, the amount of polyanion present in the composition is more than the amount of nitrification inhibitor present in the formulation. In some embodiments, the amount of polyanion present in the composition is more than the amount of fungicide present in the composition.

In some embodiments, the composition further comprises an organic solvent. The amount of solvent can vary. In some embodiments, the amount of solvent present in the composition is at least about 10% w/w, at least about 20% w/w, at least about 30% w/w, at least about 40% w/w, at least about 50% w/w, at least about 55% w/w, at least about 60% w/w, at least about 65% w/w, at least about 70% w/w, at least about 80% w/w based on the total weight of the composition. In some embodiments, the amount of solvent present in the composition is from about 10% to about 99.97% w/w, from about 28% to about 85.5% w/w, from about 30% to about 70% w/w, from about 35% from about 70% w/w, from about 40% to about 70% w/w, from about 45% to about 70% w/w, from about 49% to about 82.5%, from about 50% to about 70% w/w, from about 52% to about 70% w/w, from about 54% to about 70% w/w, from about 56% to about 70% w/w, from about 58% to about 70%, from about 58% to about 68% w/w, from about 58% from about 66% w/w, from about 58% from about 65% w/w, from about 58% to about 64 w/w, from about 63% to about 81.5%, from about 66% to about 84.5%, or from about 60% to about 65% w/w based on the total weight of the composition.

A. Fungicides

Fungicides can be classified and grouped according to common chemical functional groups and/or features that are present in their chemical structure. Information about the chemical group to which a fungicide belongs can be helpful when making decisions on when to use certain fungicide products. For example, if a fungal pathogen (i.e., disease-causing organism) responds to/is inhibited by one fungicide of a certain chemical group, then that organism will usually exhibit responsiveness to other fungicides that belong to the same chemical group. Fungicide products within the same chemical group (or family) most likely have a similar mode of action as well as a similar mode of activity. Fungicides of the current composition are selected from amide-based fungicides, dithiocarbamate-based fungicides, oxazole-containing fungicides, phosphoric acid-derived fungicides, and a combination thereof.

In some embodiments, the fungicide of the current composition is an amide-based fungicide. Exemplary amide-based fungicides include, but are not limited to, acylalanine fungicides (acylamino acid), anilide fungicides, benzanilide fungicides, and a combination thereof.

In some embodiments, the amide-based fungicide is an acylalanine fungicide (acylamino acid). The common functional group of an acylamino acid fungicide is as follows:

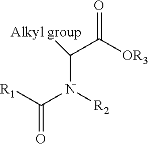

wherein R₁, R₂, and R₃ are independently selected from an (un)substituted C₁-C₁₀ alkyl group or an aromatic moiety (e.g., an (un)substituted phenyl or heteroaromatic).

Exemplary, acylalanine fungicides include, but are not limited to, benalaxyl, benalaxyl-M, furalaxyl, metalaxyl, metalaxyl-M, and a combination thereof. In some embodiments, the amide-based fungicide is selected from metalaxyl, metalaxyl-M, and a combination thereof.

In some embodiments, the amide-based fungicide is an anilide fungicide. The common functional group of an anilide fungicide is as follows:

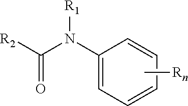

wherein R₁ and R₂ are independently selected from an (un)substituted C₁-C₁₀ alkyl group or an aromatic moiety (e.g., an (un)substituted phenyl or heteroaromatic); n is an integer from 0, 1, 2, 3, 4, and 5; and R group is selected from alkyl, halogen, amino, carboy, and the like. Exemplary anilide fungicides include, but should not be limited to, boscalid, carboxin, fenhexamid, fluxapyroxad, isotianil, metsulfovax, ofurace, oxycarboxin, penflufen, pyracarbolid, pyraziflumid, sedaxane, thifluzamide, tiadinil, vanguard, benodanil, flutolanil, mebenil, mepronil, salicylanilide, tecloftalam, fenfuram, furcabinil, methfuroxam, and a combination thereof.

In some embodiments, the fungicide is a dithiocarbamate-based fungicide. Dithiocarbamate-based fungicides are grouped into ethylene-(bis)-dithiocarbamates (EBDC), dimethyldithiocarbamates (DMDTC), and monomethyldithiocarbamates (MMDTC). The common functional group in all dithiocarbamate-based fungicides is as follows:

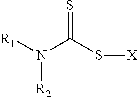

wherein R₁ and R₂ are independently selected from H or (un)substituted C₁-C₁₀ alkyl group and X is a metal ion, an ammonium ion, an (un)substituted C₁-C₁₀ alkyl group, H, or a substituted sulfur atom.

Exemplary, dithiocarbamate-based fungicides are shown in Table 1, but are not limited thereto.

TABLE 1

| | |
|---|---|
| Chemical | Structure |

EBDCs

| | |
|---|---|
| Mancozeb | 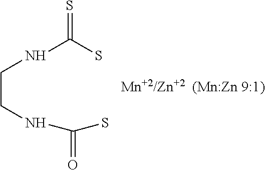 |
| Maneb | 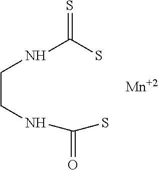 |
| Metiram | Mixture of ammoniates of zinc-ethylene- |
| | (bis)-dithiocarbamates with |
| | ethylene-(bis)-dithiocarbamic |
| | acid bimolecular and trimolecular cyclic |
| | anhydrides and disulfides. |

DMDTCs

| | |
|---|---|
| Na-Dimethyl- dithiocarbamate | 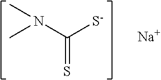 |
| Ziram | 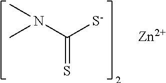 |
| Ferbam | 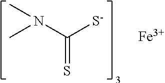 |
| Thiram | 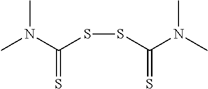 |

MMDTCs

| | |
|---|---|
| Metam sodium | 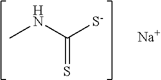 |

In some embodiments, the dithiocarbamate-based fungicide is an ethylene-(bis)-dithiocarbamate (EBDC). Exemplary ethylene-(bis)-dithiocarbamates (EBDC) include, but are not limited to, mancozeb, maneb, metiram, propineb, zineb, amobam, and a combination thereof. In one embodiment, the fungicide is selected from mancozeb, zineb, and a combination thereof.

In some embodiments, the dithiocarbamate-based fungicide is a dimethyldithiocarbamate (DMDTC). Exemplary dimethyldithiocarbamates include, but are not limited to, Na-dimethyl-dithiocarbamate, nabam, ziram, ferbam, thiram, asomate, azithiram, carbamorph, disulfiram, tecoram, urbacide, and a combination thereof. In one embodiment, the dithiocarbamate-based fungicide is thiram.

In some embodiments, the dithiocarbamate-based fungicide is a monomethyldithiocarbamate (MMDTC). Exemplary monomethyldithiocarbamates include, but are not limited to, metam sodium.

In some embodiments, the fungicide is selected from mancozeb, zineb, thiram, metalaxyl, and a combination thereof.

In some embodiments, the fungicide is an oxazole-containing fungicide. The common functional groups of oxazole-containing fungicide are as follows:

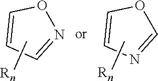

wherein n is an integer selected from 0, 1, 2, and 3 and each R group is independently selected from —C═O, —C═NNHR₁, —NHR₂, —COOR₃, an (un)substituted C₁-C₁₀ alkyl group, and an aromatic moiety (e.g., an (un)substituted phenyl or heteroaromatic) and wherein R₁-R₃ are independently selected from (un)substituted C₁-C₁₀ alkyl group and an aromatic moiety.

Exemplary oxazole-containing fungicides include, but are not limited to, famoxadone (3-anilino-5-methyl-5-(4-phenoxyphenyl)-1,3-oxazolidine-2,4-dione), oxadixyl, vinclozolin, myclozolin, dichlozoline, chlozolinate, drazoxolon, fluoxapiprolin, hymexazol, myclozolin, oxathiapiprolin, pyrisoxazole, and a combination thereof.

In some embodiments, the fungicide is a phosphoric acid-derived fungicide. Exemplary phosphoric acid-derived fungicides include, but are not limited to, phosphite-containing fungicides, phosphonate-containing fungicides, phosphoric acid-containing fungicides, and any combination thereof. In some embodiments, the phosphoric acid-derived fungicide is a phosphite-containing fungicide. The common functional group of phosphite-containing fungicides is —P(═O)(O⁻)₂H. Exemplary phosphite-containing fungicides include, but are not limited to, potassium phosphite (mono-, di-), sodium phosphite (mono-, di-), ammonium phosphite (mono-, di-), and combinations thereof.

In some embodiments, the phosphoric acid-derived fungicide is a phosphonate-containing fungicide. The common functional group of phosphonate-containing fungicides is P(═O)(OR)₂(R), wherein each R can independently be any (un)substituted alkyl group and may be optionally associated with a metal. Exemplary phosphonate-containing fungicides include, but are not limited to, ethyl hydrogen phosphonate, aluminum tris(O-ethylphosphonate) (Fosetyl-Al), potassium phosphonate, and a combination thereof.

In some embodiments, the phosphoric acid-derived fungicide comprises phosphoric acid functionality —P(═O)(OH)₂. In some embodiments, the phosphoric acid functionality is in a salt form, such as an alkali and/or alkaline earth metal. In such embodiments, the phosphoric acid can be in its anionic form selected from —P(═O)(OH)₂₀—, —P(═O)(OH)(O⁻)₂, and —P(═O)(O⁻)₃ (this particular anion is called a phosphate) with the alkali and/or alkaline earth metal being the counterion. Exemplary salt forms include, but are not limited to, phosphoric acid-derived fungicides in a salt form selected from potassium, calcium, sodium, cesium, magnesium, and combinations thereof. In some embodiments, the phosphoric acid-derived fungicide is in a salt form that is not an alkaline or alkali such as, for example, an ammonium salt. In some embodiments, the phosphoric acid-derived fungicide contains a metal (e.g., Al).

Fungicides can also be classified according to their mode of action. The mode of action refers to how a fungicide affects the metabolic process in the target cell, e.g., a fungal cell, a “fungal-like” cell or microorganism, a plant cell, an insect cell, or a combination thereof. Some fungicides can affect a single, specific site within the pathogen cell, and some fungicides can affect multiple sites. The molecular structure or shape of a fungicide is designed to bind to a certain site (i.e., “target site”) within the cell of a fungal pathogen, thus fitting like a “lock-and-key.” Once the fungicide binds to the target site, it interferes with the metabolic function of the cell at that site. Fungicides that target a specific site may have a moderate to high risk of developing resistance, and fungicides that target multiple sites typically have a low risk of developing resistance. In some embodiments, the fungicide targets a single specific site of action. In some embodiments, the fungicide targets multiple sites of action. In some embodiments, the site of action is unknown. Exemplary modes of action include, but are not limited to, inhibition of nucleic acid metabolism, cycloskeleton and/or motor protein(s), cellular respiration, amino acid and protein synthesis, signal transduction, lipid synthesis and/or transport, membrane sterol biosynthesis, cell wall biosynthesis, or a combination thereof.

In some embodiments, the fungicide targets an organism that is not a fungal-like cell. In some embodiments, the fungicide selectively targets an organism with a different mode of action than a fungal-like cell. For example, in some embodiments, the fungicide selectively targets an organism that modulates nitrification. In some embodiments, the fungicide selectively targets one mode of action, such as nitrification, over other modes of action. The degree of selectivity can vary, but can range from about 2 fold to about 1,000 fold, about 10 fold to about 500 fold, or from about 100 to about 250 fold.

The mode of activity refers to how the fungicide (i.e., “active ingredient”) delivers its disease control to the plant, either on the outside (contact activity) or inside (penetrant activity) of the plant. The length of disease control (i.e., suppression or inhibition of pathogen growth and development) is often influenced by the mode of activity of the fungicide. Fungicides with a contact mode of activity (i.e., the fungicide remains on the surface of the plant) can typically provide protection for about 1 to about 14 days, preferably about 7 to about 14 days, and does not reduce further infection and colonization of plant tissues after the pathogen penetrates the plant. When applied to plant surfaces, penetrant fungicides “move” into the plant in quantities sufficient to be toxic or inhibit the pathogen inside the plant. Fungicides categorized as localized penetrants move into the plant tissue but remain at the point of entry and generally provide plant protection for about 14 to about 21 days. Fungicides categorized as acropetal penetrants enter the plant and move upward in the xylem, and some will also exhibit translaminar movement across leaf tissues. Fungicides that are acropetal penetrants can provide plant protection in the range of about 14 to about 28 days or even longer. A true “systemic” penetrant enters the plant and moves upward in the xylem, downward in the phloem, and also translaminar, and can provide about 14 to about 28 days of protection or sometimes even longer.

In some embodiments, the fungicide is a contact fungicide. In some embodiments, the fungicide is a penetrant fungicide selected from a local penetrant or a systemic penetrant. Examples of a systemic penetrant include, but are not limited to, an acropetal penetrant and/or a translaminar penetrant.

In some embodiments, the target cell is a fungal-like cell or microorganism. In some embodiments, the target cell is a microorganism such as an oomycete. Oomycetes form a diverse group of fungus-like eukaryotic microorganisms, also known as water molds, that include saprophytes as well as pathogens of plants, insects, crustaceans, fish, vertebrate animals, and various microorganisms. A multitude of saprophytic oomycetes primarily inhabit aquatic and moist soil habitats and play key roles in decomposition and recycling of organic matter. Because of their filamentous growth habit, nutrition by absorption, and reproduction via spores, oomycetes were long regarded by plant pathologists as lower fungi. However, as our understanding of evolutionary relationships has grown, it is now clear that this group of organisms is unrelated to the true fungi. Indeed, fungi appear more closely related to animals than to oomycetes, and oomycetes are more closely related to algae and green plants. In particular, plant pathogenic species, such as those of the genus Phytophthora are the best studied oomycetes. Species of the genus Phytophthora (the ‘plant destroyer’ in Greek) are arguably the most devastating pathogens of dicotyledonous plants. They cause enormous economic damage on important crop species such as potato, tomato, pepper, soybean, and alfalfa, as well as environmental damage in natural ecosystems. Virtually every dicot plant is affected by one or more species of Phytophthora, and several monocot species are infected as well. Over 60 species of the genus Phytophthora, several genera of the biotrophic downy mildews, and more than 100 species of the genus Pythium are comprised by the oomycetes. Many of these pathogens cause devastating diseases on several crop and ornamental plants that are notoriously difficult to manage. Other oomycetes cause economically important diseases in animals.

In some embodiments, the disclosed composition and/or fungicide inhibits the biological activity of the microorganism (e.g., oomycetes) by at least about 10%, 20%, 30%, 40%, 50%, 60%, 70%, 80%, or 90%. Such biological activity includes, but is not limited to, the formation/growth of the microorganism; multiplication of the microorganism and/or increase of the number of the microorganism by at least about 10%, 20%, 30%, 40%, 50%, 60%, 70%, 80%, or 90%. In some embodiments, the inhibition of such microorganisms indirectly inhibit nitrification. In some embodiments, the fungicide inhibits nitrification directly, e.g., by inhibition one or more of the microorganisms involved in nitrification, such as, but not limited to ammonia-oxidizing bacteria (e.g., genera of Nitrosomonas and/or Nitrosococcus) and/or ammonia-oxidizing archaea.

B. Nitrification Inhibitor(s)

Nitrification inhibitors are chemical compounds that slow the nitrification occurring in fertilizers that are applied to the soil. These inhibitors reduce the losses of nitrogen in the soils that would otherwise be used by crops by inhibiting nitrifying bacteria (e.g., ammonia-oxidizing bacteria (AOB) and/or nitrite-oxidizing bacteria (NOB)) present in the soil. In some embodiments, the nitrification inhibitor inhibits AOB. In some embodiments, the nitrification inhibitor inhibits NOB. In some embodiments, the nitrification inhibitor inhibits AOB and NOB. The nitrification inhibitor can further be grouped into classes based on common structural features and functional groups. Examples of nitrification inhibitors include, but are not limited to, S-containing compounds, cyano-containing compounds, N-heterocyclic-containing compounds, and a combination thereof.

In some embodiments, the nitrification inhibitor is a sulfur-containing compound. The sulfur (S) atom can be part of structural moieties such as thiosulfates, thioureas, thiazoles, thiophosphoryls and the like. Exemplary sulfur-containing compounds include, but are not limited to, ammonium thiosulfate (ATS), 1-amino-2-thiourea (ASU), 2-mercapto-benzothiazole (MBT), 2,4-triazol thiourea (TU), 2-sulfanilamidothiazole (ST), 5-ethoxy-3-trichloromethyl-1,2,4-thiodiazole (terrazole), thiophosphoryl triamide, and a combination thereof.

In some embodiments, the nitrification inhibitor is a cyano-containing compound, which are compounds that contain one or more cyano (—CN) functional groups. Exemplary cyano-containing compounds include, but are not limited to, 2-cyano-1-((4-oxo-1,3,5-triazinan-1-yl)methyl)guanidine, 1-((2-cyanoguanidino)methyl)urea, 2-cyano-1-((2-cyanoguanidino)methyl)guanidine, dicyandiamide (DCD), pronitridine, and a combination thereof.

In some embodiments, the nitrification inhibitor is a N-heterocyclic compound. N-heterocyclic compounds are classified by their ring structure and can include multiple nitrogen atoms. Exemplary ring structures include, but are not limited to, pyridine, pyrrole, pyridazine, pyrazole, and/or imidazole. Exemplary N-heterocyclic compounds include, but are not limited to, 2-(3,4-dimethyl-1H-pyrazol-1-yl)succinic acid (DMPSA1), 2-(4,5-dimethyl-1H-pyrazol-1-yl)succinic acid (DMPSA2), 3,4-dimethyl pyrazolium salts, 2,4-triazole (TZ), 4-chloro-3-methylpyrazole (CIMP), N-((3(5)-methyl-1H-pyrazole-1-yl)methyl)acetamide, N-((3(5)-methyl-1H-pyrazole-1-yl)methyl) formamide, N-((3(5),4-dimethylpyrazole-1-yl) methyl)formamide, N-((4-chloro-3 (5)-methyl-pyrazole-1-yl)methyl)formamide, 2-chloro-6-(trichloromethyl)-pyridine (nitrapyrin), 3,4-dimethyl pyrazole phosphate (DMPP), 4,5-dimethyl pyrazole phosphate (ENTEC), 3,4-dimethylpyrazole, 4,5-dimethylpyrazole (DMP), 4-amino-1,2,4-triazole hydrochloride (ATC), 2-amino-4-chloro-6-methylpyrimidine (AM), and a combination thereof.

In some embodiments, the nitrification inhibitor is selected from nitrapyrin, DCD, DMPP, pronitridine, and salts and/or combinations thereof. In some embodiments, the nitrification inhibitor is nitrapyrin.

C. Polyanion(s)

The polyanions as disclosed herein comprises a non-polymeric polyanion, a polyanionic polymer, and a combination thereof. Polyanionic species herein include those polyanionic polymers disclosed in WO 2011/016898; WO 2015/031521; US2017/0183492; U.S. Pat. Nos. 10,336,659 and 10,059,636, each of which is incorporated by reference in its entirety.

Polyanionic species also include non-polymeric molecule having two or more negatively charged groups. Suitable negatively charged groups include, but are not limited to, carboxyl groups, sulfonate groups, phosphonate groups, and mixtures thereof.

In some embodiments, the polyanion associates with the nitrification inhibitor to form a complex. In some embodiments, the polyanion does not associate with the nitrification inhibitor and forms no complex. Complex formation is depended upon the chemical structure and/or physical properties of the nitrification inhibitor and/or polyanion. For example, polyanions (polyanionic species) suitable for formation of useful complexes with a nitrification inhibitor (e.g., nitrapyrin) have one or more of: a formal charge of −2 or greater (i.e., greater negative charge) in dilute aqueous solution at pH 10, lower vapor pressure when compared to the vapor pressure of the nitrification inhibitor (e.g., nitrapyrin) and/or lower volatility when compared to the volatility of the nitrification inhibitor. In some embodiments, for example, the vapor pressure of the nitrification inhibitor (e.g., nitrapyrin) in a nitrification inhibitor-polyanion complex (e.g., nitrapyrin complex) is less than 0.5 mmHg at 20° C. Furthermore, the amount of loading of the nitrification inhibitor (e.g., nitrapyrin) into a formulation has been significantly increased.

In some embodiments, the MW/charge ratio of a polyanion is about 50-200, 50-175, 50-150, 50-125, 50-110, 50-105, 50-100, 50-95, 50-90, 50-85, 50-80, 50-75, 65-200, 65-175, 65-150, 65-125, 65-110, 65-105, 90-115, 90-100, 90-105, 95-120, 95-115, 95-110, 95-105, 50, 55, 60, 65, 70, 75, 80, 85, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 1127, 128, 129, or 130. In some embodiments, the charge ratio (molecular weight/charge) is less than 200, less than 175, less than 150, less than 140, less than 130, less than 125, less than 120, less than 115, less than 110, less than 105, less than 100, less than 95, less than 90, less than 85, less than 80, less than 75, or less than 70. In some embodiments, the MW/charge ratio of a polyanion is greater than 50, greater than 55, greater than 60, greater than 65, greater than 70, greater than 75, greater than 80, greater than 85, greater than 90, greater than 95, or greater than 100.

In some embodiments, the polyanion has a formal charge greater than −2, greater than −3, greater than −4, greater than −5, greater than −6, greater than −7, greater than −8, greater than −9, greater than −10, greater than −15, or greater than −20 at pH 10. As used herein, greater than “−n” means greater negative charge, e.g., −3 has greater negative charge than −2. In some embodiments, the polyanions are polymeric materials having a plurality (two or more) of anionic functional groups, including, but not limited to, carboxylates, sulfonates, and the like.

In some embodiments, the polyanion is a non-polymeric molecule having a plurality (two or more) of anionic functional groups, including, but not limited to, carboxylates, sulfonates, and the like. Non-polymeric polyanions include, but are not limited to, di-, tri-, tetra-, penta-, hexa-, hepta-, octa-, nona-, and deca-carboxyls; di-, tri-, tetra-, penta-, hexa-, hepta-, octa-, nona-, and deca-sulfonates; and di-, tri-, tetra-, penta-, hexa-, hepta-, octa-, nona- and deca-phosphonates. In some embodiment, a non-polymeric polyanion comprises an aliphatic dibasic acid. In some embodiments, a non-polymeric polyanion comprises aromatic carboxylic acid containing a 2-6 carboxylic acid groups. In some embodiments, a non-polymeric polyanion comprises aliphatic carboxylic acid containing a 2-6 carboxylic acid groups. Exemplary non-polymeric polycarboxylic acids, phosphonates, and aromatic carboxylic acids suitable for forming nitrapyrin complexes include, but are not limited to, malic acid, tartaric acid, etidronic acid, succinic acid, adipic acid, isophthalic acid, aconitic, trimesic, biphenyl-3,3′,5,5′-tetracarboxylic acid, furantetracarboxylic acid, sebacic acid, azelaic acid, isoterephtallic acid, isophthallic acid, pyromellitic acid, and mellitic acid.

For nitrification inhibitors complexed with a polyanion the amount of nitrification inhibitor substitution can vary. In some embodiments, the amount of nitrification inhibitor (e.g., nitrapyrin) substitution on the polyanion is from about 5% to about 90% of the available anionic groups, or from about 10% to about 90% of the available anionic groups, or from about 20% to about 90% of the available anionic groups, or from about 30% to about 80% of the available anionic groups, or from about 40% to about 80% of the available anionic groups, or from about 40% to about 75% of the available anionic groups, or from about 50% to about 75% of the available anionic groups. In some embodiments, the nitrification inhibitor-polyanionic complex (e.g., nitrapyrin complex) composition contains from about 50 g/mol anionic species to about 200 g/mol anionic species; or from about 75 g/mol anionic species to about 190 g/mol anionic species; or from about 100 g/mol anionic species to about 180 g/mol anionic species; or from about 125 g/mol anionic species to about 175 g/mol anionic species.

In some embodiments, the polyanionic species comprises a polyanionic polymer. In some embodiments, a polyanionic polymer comprises a copolymer containing two or more different repeat units. A copolymer can have two, three, four, or more different repeat units. As used herein, a copolymer contains two or more different repeat units. As used herein, a terpolymer contains three or more different repeat units. As used herein, a tetrapolymer contains four or more different repeat units. A polyanionic polymer can be, but is not limited to, random copolymer, alternating copolymer, periodic copolymer, statistical copolymer, or block copolymer. In some embodiments, the polyanion can be a carboxylated polymer, a sulfonated polymer or an all-sulfonated polymer. An all-sulfonated polymer can be, but is not limited to, polystyrene sulfonate. Additionally, the sulfur can be provided by polyanionic species such as ethanedisulfonic acid and 1,3-benzenedisulfonic acid.

In some embodiments, the polyanionic polymers have a high carboxylate content and sulfonate repeat units, which are very soluble in water and biodegradable. In some embodiments, a polyanionic polymer has a single repeating unit, wherein the repeating unit contains a negatively charged group. In some embodiments, a polyanionic polymer comprises a copolymer having two or more repeating units wherein at least one of the repeating units contains a negatively charged group. In some embodiments, a polyanionic polymer comprises a dipolymer having two repeating units wherein at one or both of the repeating units contains a negatively charged group. In some embodiments, a polyanionic polymer comprises a terpolymer having three or more repeating units wherein at least one of the repeating units contains a negatively charged group. In some embodiments, the polyanionic polymers are tetrapolymers having at least four different repeat units distributed along the lengths of the polymer chains, preferably with at least one repeat unit each of maleic, itaconic, and sulfonate repeat units. The repeat units are derived from corresponding monomers used in the synthesis of the polymers. In some embodiments, a polyanionic polymer contains type B, type C, and/or type G repeat units as described in detail below. In some embodiments, a polyanionic polymer contains type B and type C, type B and type G, or type C and type G repeat units as described in detail below. In some embodiments, a polyanionic polymer contains at least one repeat unit from each of three separately defined categories of repeat units, referred to herein as type B, type C, and type G repeat units, and described in detail below. In some embodiments, at least about 90 mole percent of the repeat units therein are selected from the group consisting of type B, C, and G repeat units, and mixtures thereof, the repeat units being randomly located along the polyanionic polymer. In some embodiments, the polyanionic polymer contains no more than about 10 mole percent or no more than 5 mole percent of any of (i) non-carboxylate olefin repeat units, (ii) ether repeat units, (iii) non-sulfonated monocarboxylic repeat units, (iv) non-sulfonated monocarboxylic repeat units, and/or (v) amide-containing repeat units. “Non-carboxylate” and “non-sulfonated” refer to repeat units having essentially no carboxylate groups or sulfonate groups in the corresponding repeat units.

In some embodiments, a polyanionic polymer comprises a copolymer comprising the structure represented by:

poly(Aₐ-co-A′_{a′}-co-A″_{a″}-co-D_{d})

wherein A is a first repeat unit containing a negatively charged group, A′ is optional and if present is a second repeat unit containing a negatively charged group, A″ is optional and if present is a third repeat unit containing a negatively charged group, and D is optional and if present is an uncharged repeat unit. A polyanionic polymer can contain additional negatively charged repeat units or uncharged repeat units. a is an integer greater than or equal to 1. a′, a″, and d are integers greater than or equal to zero. The value of (a+a′+a″) is greater than or equal to 2.

In some embodiments, the polyanionic polymer comprises a random copolymer having structure represented by:

poly(B_{b}-co-C_{c}-co-G_{g}-co-G′_{g′})

wherein B and C are type B and type C repeat units as described below, G and G′ are independently type G repeat units as described below, c is an integer greater than zero, and b, g and g′ are integers greater than or equal to zero. In some embodiments, the ratio of b:c:(g+g′) is about 1-70:1-80:0-65. In some embodiments, the ratio of b:c:(g+g′) is about 20-65:15-75:1-35. In some embodiments, the ratio of b:c:(g+g′) is about 35-55:20-55:1-25. In some embodiments, the ratio of b+c to g+g′ is about 0.5-20:1, about 1-20:1, or about 1-10:1. In some embodiments, the ratio of b:c:g:g′ is about 10:90:0:0, about 60:40:0:0, about 50:50:0:0, or about 0:100:0:0. In some embodiments, the ratio of b:c:g:g′ is about 45:35:15:5. In some embodiments, the ratio of b:c:g:g′ is about 45:50:4:1. In some embodiments, the polymers contain less than 10%, less than 4%, less than 3%, less than 2%, less than 1%, less than 0.5%, less than 0.1%, less than 0.05%, less than 0.01%, or 0% repeat units that are not B, C, G, or G′.

In some embodiments, the polyanionic polymer comprises a tetrapolymer having repeat units individually and independently selected from the group consisting of type B, type C, and type G repeat units, and mixtures thereof, described in detail below. In some embodiments, a tetrapolymer contains more than four different repeat units. In some embodiments, the additional repeat units are selected from the group consisting of type B, type C, and type G repeat units, and mixtures thereof, as well as other monomers or repeat units not being type B, C, or G repeat units.

In some embodiments, a polyanionic polymer contains at least one repeat unit from each of the B, C, and G types, one other repeat unit selected from the group consisting of type B, type C, and type G repeat units, and optionally other repeat units not selected from type B, type C, and type G repeat units. In some embodiments, a polyanionic polymers comprise a single type B repeat unit, a single type C repeat unit, and two different type G repeat units, or two different type B repeat units, a single type C repeat unit, and one or more different type G repeat units.

In some embodiments, the polyanionic polymers comprise at least 90% or at least 96 mole percent of the repeat units therein selected from the group consisting of type B, C, and G repeat units, and mixtures thereof. In some embodiments, the polyanionic polymers consist of or consist essentially of repeat units selected from the group consisting of type B, C, and G repeat units, and mixtures thereof. In some embodiments, the polyanionic polymers contain <3, <2, <1, <0.5, <0.1, <0.05, <0.01, or 0 mole percent ester groups and/or non-carboxylate olefin groups.

In some embodiments, the total amount of type B repeat units in the polymer is from about 1-70 mole percent, the total amount of type C repeat units in the polymer is from about 1-80 mole percent, and the total amount of type G repeat units in the polymer is from about 0.1-65 mole percent, where the total amount of all of the repeat units in the polymer is taken as 100 mole percent. In some embodiments, the total amount of type B repeat units in the polymer is from about 20-65 mole percent, the total amount of type C repeat units in the polymer is from about 15-75 mole percent, and the total amount of type G repeat units in the polymer is from about 1-35 mole percent, where the total amount of all of the repeat units in the polymer is taken as 100 mole percent.

In some embodiments, the polyanionic polymers have one type B repeat unit, one type C repeat unit, and two different type G repeat units. In some embodiments, the one type B repeat unit is derived from maleic acid, the one type C repeat unit is derived from itaconic acid, and two type G repeat units are respectively derived from methallylsulfonic acid and allylsulfonic acid. In such polymers, the type B repeat unit can be present at a level of from about 35-55 mole percent, the type C repeat unit can present at a level of from about 20-55 mole percent, the type G repeat unit derived from methallylsulfonic acid can present at a level of from about 1-25 mole percent, and the type G repeat unit derived from allylsulfonic acid can be present at a level of from about 1-25 mole percent, where the total amount of all of the repeat units in the polymer is taken as 100 mole percent. In other embodiments, the polyanionic polymers comprise two different type B repeat units, one type C repeat unit, and one type G repeat unit. In some embodiments, the polyanionic polymer contains at least one repeat unit not selected from the group consisting of type B, type C, and type G repeat units.

In some embodiments, the mole ratio of the type B and type C repeat units in combination to the type G repeat units (that is, the mole ratio of (B+C)/G) should be about 0.5-20:1, about 2:1-20:1, or about 2.5:1-10:1. Still further, the polymers should be essentially free (e.g., less than about 1 mole percent) of alkyloxylates or alkylene oxide (e.g., ethylene oxide) containing repeat units, and most desirably entirely free thereof.

In some embodiments, the polyanionic polymers have a high percentage of the repeat units thereof bearing at least one anionic group, e.g., at least about 80 mole percent, at least about 90 mole percent, at least about 95 mole percent, or essentially all of the repeat units contain at least one anionic group. It will be appreciated that the type B and C repeat units have two anionic groups per repeat unit, whereas the preferred sulfonate repeat units have one anionic group per repeat unit.

In some embodiments, a polyanionic terpolymer comprises a polymer backbone composition range (by mole percent, using the parent monomer names of the corresponding repeat units) of: maleic acid 35-50%; itaconic acid 20-55%; methallylsulfonic acid 1-25%; and allylsulfonic sulfonic acid 1-20%, where the total amount of all of the repeat units in the polymer is taken as 100 mole percent.

The molecular weight of the polymers can be varied, depending upon the desired properties. The molecular weight distribution for any of the polyanionic polymers can be measured by size exclusion chromatography. In some embodiments, a polyanionic polymer has a molecule weight greater than 118, greater than 150, greater than 200, greater than 300, greater than 400, or greater than 500 Da. In some embodiments, the polyanionic polymers have a molecular weight of about 100-50,000 Da. In some embodiments, the polyanionic polymers have a molecular weight of about 100-5000 Da, about 200-5000 Da, about 400-5000 Da, or about 1000-5000 Da. In some embodiments, at least 90% of the finished polyanionic polymer is at or above a molecular weight of about 100, 200, 400, or 1000 measured by size exclusion chromatography in 0.1 M sodium nitrate solution via refractive index detection at 35° C. using polyethylene glycol standards. Other methods of determining polymer molecular known in the art can also be employed.

Type B Repeat Units

Type B repeat units can be selected from the group consisting of repeat units derived from substituted and unsubstituted monomers of maleic acid and/or maleic anhydride, fumaric acid and/or fumaric anhydride, mesaconic acid and/or mesaconic anhydride, mixtures of the foregoing, and any isomers, esters, acid chlorides, and partial or complete salts of any of the foregoing. Type B repeat units may be substituted with one or more C₁-C₆ straight or branched chain alkyl groups substantially free of ring structures and halo atoms, wherein substantially free means no more than about 5 mole percent or no more than about 1 mole percent of either ring structures or halo substituent. Substituents are normally bound to one of the carbons of a carbon-carbon double bond of the monomer(s) employed.

Those skilled in the art will appreciate the usefulness of in situ conversion of acid anhydrides to acids in a reaction vessel just before or even during a reaction. However, it is also understood that when corresponding esters (e.g., maleic or citraconic esters) are used as monomers during the initial polymerization, this should be followed by hydrolysis (acid or base) of pendant ester groups to generate a final carboxylated polymer substantially free of ester groups.

### Type C Repeat Units

Type C repeat units can be selected from the group consisting of repeat units derived from substituted or unsubstituted monomers of itaconic acid or itaconic anhydride, and any isomers, esters, and the partial or complete salts of any of the foregoing and mixtures of any of the foregoing. Type C repeat units may be substituted with one or more C₁-C₆ straight or branched chain alkyl groups substantially free of ring structures and halo atoms.

The itaconic acid monomer used to form type C repeat unit has one carboxyl group, which is not directly attached to the unsaturated carbon-carbon double bond used in the polymerization of the monomer. In some embodiments, a type C repeat unit has one carboxyl group directly bound to the polymer backbone, and another carboxyl group spaced by a carbon atom from the polymer backbone. The definitions and discussion relating to “substituted,” “salt,” and useful salt-forming cations (metals, amines, and mixtures thereof) with respect to the type C repeat units, are the same as those set forth for the type B repeat units.

In some embodiments, the type C repeat unit is an unsubstituted itaconic acid or itaconic anhydride, either alone or in various mixtures. If itaconic anhydride is used as a starting monomer, it is normally useful to convert the itaconic anhydride monomer to the acid form in a reaction vessel just before or even during the polymerization reaction. Any remaining ester groups in the polymer are normally hydrolyzed, so that the final carboxylated polymer is substantially free of ester groups.

### Type G Repeat Units

Type G repeat units can be selected from the group consisting of repeat units derived from substituted or unsubstituted sulfonated monomers possessing at least one carbon-carbon double bond and at least one sulfonate group and which are substantially free of aromatic rings and amide groups, and any isomers, and the partial or complete salts of any of the foregoing, and mixtures of any of the foregoing. Type G repeat units may be substituted with one or more C₁-C₆ straight or branched chain alkyl groups substantially free of ring structures and halo atoms.

In some embodiments, type G repeat units can be selected from the group consisting of C₁-C₈ straight or branched chain alkenyl sulfonates, substituted forms thereof, and any isomers or salts of any of the foregoing; especially preferred are alkenyl sulfonates selected from the group consisting of vinyl, allyl, and methallylsulfonic acids or salts.

In some embodiments, the type G repeat units are derived from vinylsulfonic acid, allylsulfonic acid, and methallylsulfonic acid, either alone or in various mixtures. It has also been found that alkali metal salts of these acids are also highly useful as monomers. In this connection, it was unexpectedly discovered that during polymerization reactions yielding the novel polymers of the invention, the presence of mixtures of alkali metal salts of these monomers with acid forms thereof does not inhibit completion of the polymerization reaction. By the same token, mixtures of monomers of maleic acid, itaconic acid, sodium allyl sulfonate, and sodium methallyl sulfonate do not inhibit the polymerization reaction.

Syntheses of BC and BCG polymers are described in WO 2015/031521, incorporated herein by reference in its entirety.

B.1. Class I Polymers

### Class IA Polymers

Class IA polymers contain both carboxylate and sulfonate functional groups, but are not the tetra- and higher order polymers of Class I. For example, terpolymers of maleic, itaconic, and allylsulfonic repeat units, which are per se known in the prior art, will function as the polyanionic polymer component of the compositions of the invention. The Class IA polymers thus are normally homopolymers, copolymers, and terpolymers, advantageously including repeat units individually and independently selected from the group consisting of type B, type C, and type G repeat units, without the need for any additional repeat units. Such polymers can be synthesized in any known fashion, and can also be produced using the previously described Class I polymer synthesis.

Class IA polymers preferably have the same molecular weight ranges and the other specific parameters (e.g., pH and polymer solids loading) previously described in connection with the Class I polymers, and maybe converted to partial or complete salts using the same techniques described with reference to the Class I polymers. Class IA polymers are most advantageously synthesized using the techniques described above in connection with the Class I polymers.

B.2. Class II Polymers

Broadly speaking, the polyanionic polymers of this class are of the type disclosed in U.S. Pat. No. 8,043,995, which is incorporated herein by reference in its entirety. The polymers include repeat units derived from at least two different monomers individually and respectively taken from the group consisting of what have been denominated for ease of reference as B′ and C′ monomers; alternately, the polymers may be formed as homopolymers or copolymers from recurring C′ monomers. The repeat units may be randomly distributed throughout the polymer chains.

In detail, repeat unit B′ is of the general formula

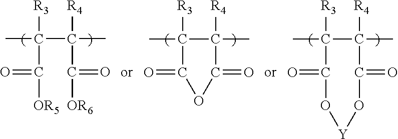

and/or repeat unit C′ is of the general formula

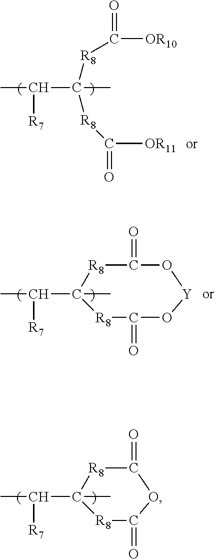

wherein each R₇ is individually and respectively selected from the group consisting of H, OH, C₁-C₃₀ straight, branched chain and cyclic alkyl or aryl groups, C₁-C₃₀ straight, branched chain and cyclic alkyl or aryl formate (C₀), acetate (C₁), propionate (C₂), butyrate (C₃), etc., up to C₃₀ based ester groups, R′CO2 groups, OR′ groups and COOX groups, wherein R′ is selected from the group consisting of C₁-C₃₀ straight, branched chain and cyclic alkyl or aryl groups and X is selected from the group consisting of H, the alkali metals, NH₄ and the C₁-C₄ alkyl ammonium groups, R₃ and R₄ are individually and respectively selected from the group consisting of H, C₁-C₃₀ straight, branched chain and cyclic alkyl or aryl groups, R₅, R₆, R₁₀, and R₁₁ are individually and respectively selected from the group consisting of H, the alkali metals, NH₄ and the C₁-C₄ alkyl ammonium groups, Y is selected from the group consisting of Fe, Mn, Mg, Zn, Cu, Ni, Co, Mo, V, W, the alkali metals, the alkaline earth metals, polyatomic cations containing any of the foregoing (e.g., VO⁺²), amines, and mixtures thereof; and R₈ and R₉ are individually and respectively selected from the group consisting of nothing (i.e., the groups are nonexistent), CH₂, C₂H₄, and C₃H₆.

As can be appreciated, the Class II polymers typically have different types and sequences of repeat units. For example, a Class II polymer comprising B′ and C′ repeat units may include all three forms of B′ repeat units and all three forms of C′ repeat units. However, for reasons of cost and ease of synthesis, the most useful Class II polymers are made up of B′ and C′ repeat units. In the case of the Class II polymers made up principally of B′ and C′ repeat units, R₅, R₆, R₁₀, and R₁₁ are individually and respectively selected from the group consisting of H, the alkali metals, NH₄, and the C₁-C₄ alkyl ammonium groups. This particular Class II polymer is sometimes referred to as a butanedioic methylenesuccinic acid copolymer and can include various salts and derivatives thereof.

The Class II polymers may have a wide range of repeat unit concentrations in the polymer. For example, Class II polymers having varying ratios of B′:C′ (e.g., 10:90, 60:40, 50:50, and even 0:100) are contemplated and embraced by the present invention. Such polymers would be produced by varying monomer amounts in the reaction mixture from which the final product is eventually produced and the B′ and C′ type repeat units may be arranged in the polymer backbone in random order or in an alternating pattern.

The Class II polymers may have a wide variety of molecular weights, ranging for example from 500-5,000,000, depending chiefly upon the desired end use. Additionally, n can range from about 1-10,000 and more preferably from about 1-5,000.

Class II polymers can be synthesized using dicarboxylic acid monomers, as well as precursors and derivatives thereof. For example, polymers containing mono- and dicarboxylic acid repeat units with vinyl ester repeat units and vinyl alcohol repeat units are contemplated; however, polymers principally comprised of dicarboxylic acid repeat units are preferred (e.g., at least about 85%, and more preferably at least about 93%, of the repeat units are of this character). Class II polymers may be readily complexed with salt-forming cations using conventional methods and reactants.

In some embodiments, the Class II polymers are composed of maleic and itaconic B′ and C′ repeat units and have the generalized formula:

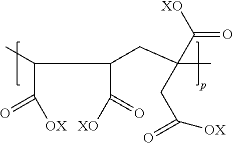

where X is either H or another salt-forming cation, depending upon the level of salt formation.

In a specific example of the synthesis of a maleic-itaconic Class II polymer, acetone (803 g), maleic anhydride (140 g), itaconic acid (185 g) and benzoyl peroxide (11 g) were stirred together under inert gas in a reactor. The reactor provided included a suitably sized cylindrical jacketed glass reactor with mechanical agitator, a contents temperature measurement device in contact with the contents of the reactor, an inert gas inlet, and a removable reflux condenser. This mixture was heated by circulating heated oil in the reactor jacket and stirred vigorously at an internal temperature of about 65-70° C. This reaction was carried out over a period of about 5 hours. At this point, the contents of the reaction vessel were poured into 300 g water with vigorous mixing. This gave a clear solution. The solution was subjected to distillation at reduced pressure to drive off excess solvent and water. After sufficient solvent and water have been removed, the solid product of the reaction precipitates from the concentrated solution and is recovered. The solids are subsequently dried in vacuo.

In some embodiments, the polyanionic polymer has repeat unit molar composition of 45 mole percent maleic repeat units, 50 mole percent itaconic repeat units, 4 mole percent methallylsulfonate repeat units, and 1 mole percent allylsulfonate repeat units. This polymer is referred to herein as the “T5” polymer.

In some embodiments, the polyanionic polymer comprises: 45% maleic repeat units, 35% itaconic repeat units, 15% methallylsulfonate repeat units, and 5% allylsulfonate repeat units.

In some embodiments, the polyanionic polymer comprises: 45% maleic repeat units, 50% itaconic repeat units, 4% methallylsulfonate repeat units, and 1% allylsulfonate repeat units.

In some embodiments, the nitrification inhibitor (e.g., nitrapyrin) can form complexes with a ligand (i.e., a polyanion). In some embodiments, such complexes can be formed with two or more different polyanionic polymers. In some embodiments, such complexes include suitable non-volatile polyanionic species as disclosed herein.

In embodiments, the nitrification inhibitor (e.g., nitrapyrin) can be present as a mixture of the complex and the free form. The ratio of complex to free form can be from 1000:1 to 0.1:1 such that the compositions can reduce the volatilization losses of the nitrification inhibitor (e.g., nitrapyrin) to the atmosphere by at least 10% as compared to an identical composition lacking the complex described herein. Accordingly, the compositions described herein can simultaneously comprise the complex and the free form so long as the volatilization losses are reduced as described elsewhere herein.

The fungicide, nitrification inhibitor and polyanion (optionally complexed with the nitrification inhibitor) can be used neat or can include an organic solvent, as well as other ingredients to form useful compositions. In some embodiments, the described compositions and formulations contain relatively little to no water. In some embodiments, the compositions disclosed herein comprise a fungicide selected from mancozeb, metalaxyl, thiram, zineb, and any combination thereof; a nitrification inhibitor selected from nitrapyrin, DCD, DMPP, pronitiridine, and any combination thereof; and a polyanion. In some embodiments, the composition comprises mancozeb; a nitrification inhibitor selected from nitrapyrin, DCD, DMPP, pronitiridine, and any combination thereof; and a polyanion. In some embodiments, the composition comprises metalaxyl; a nitrification inhibitor selected from nitrapyrin, DCD, DMPP, pronitiridine, and any combination thereof; and a polyanion. In some embodiments, the composition comprises zineb; a nitrification inhibitor selected from nitrapyrin, DCD, DMPP, pronitiridine, and any combination thereof; and a polyanion. In some embodiments, the composition comprises thiram, a nitrification inhibitor selected from nitrapyrin, DCD, DMPP, pronitiridine, and any combination thereof; and a polyanion. In some embodiments, the composition comprises thiram, nitrapyrin, and a polyanion. In some embodiments, the composition comprises thiram, nitrapyrin, and a non-polymeric polyanion. In some embodiments, the composition comprises thiram, nitrapyrin, and adipic acid. In some embodiments, the composition comprises thiram, nitrapyrin, and a polyanion, wherein the polyanion is a combination of non-polymeric polyanion and polyanionic polymer. In some embodiments, the composition comprises thiram, nitrapyrin, adipic acid and T5 tetrapolymer.

B.3. Organic Solvents

In some embodiments, the solvent is an organic solvent. In some embodiments, the solvent is a polar organic solvent. In some embodiments, the polar organic solvent is EPA approved. EPA-approved solvents are those that are approved for food and non-food use and found in the electronic code of federal regulations, for example in Title 40, Chapter I, Subchapter E, Part 180. EPA-approved solvents include, but are not limited to, the solvents listed in Table 1.

TABLE 1
EPA-approved solvents

| | |
|---|---|
| 1,3-Propanediol (CAS Reg. No. 504-63-2) | Isopropyl-3-hydroxybutyrate (CAS Reg. No. |
| | 54074-94-1) |
| 2-Ethylhexanol | Kerosene, U.S.P. reagent |
| 2-methyl-1,3-propanediol (CAS Reg. No. | Lactic acid |
| 2163-42-0) | |
| 2-Methyl-2,4-pentanediol | Lactic acid, 2-ethylhexyl ester (CAS Reg. |
| | No. 6283-86-9) |
| Acetic anhydride | Lactic acid, n-propyl ester, (S); (CAS Reg. |
| | No. 53651-69-7) |
| Acetone (CAS Reg. No. 67-64-1) | Mesityl oxide |
| Ammonium hydroxide | Methyl 5-(dimethylamino)-2-methyl-5- |
| | oxopentanoate (1174627-68-9) |
| Amyl acetate | Methyl alcohol |
| Benzyl acetate (CAS Reg. No. 140-11-4) | Methyl esters of fatty acids derived from |
| | edible fats and oils |
| C₁₀₋₁₁ rich aromatic hydrocarbons (CAS | Methyl isobutyl ketone |
| Reg. No. 64742-94-5) | |
| C₁₁₋₁₂ rich aromatic hydrocarbons (CAS | Methyl isobutyrate (CAS Reg. No. 547-63-7) |
| Reg. No. 64742-94-5) | |
| C₉ rich aromatic hydrocarbons (CAS Reg. | Methyl n-amyl ketone (CAS Reg. No. 110-43-0) |
| No. 64742-95-6) | |
| Choline chloride (CAS Reg. No. 67-48-1) | Mineral oil |
| Cod liver oil | Morpholine 4-C₆₋₁₂ Acyl Derivatives (CAS |
| | Reg. No. 887947-29-7) |
| Cyclohexane | n-Butanol (CAS Reg. No. 71-36-3) |
| Cyclohexanone | n-Butyl benzoate (CAS Reg. No. 136-60-7) |
| Decanamide, N,N-dimethyl (CAS Reg. No. | n-Butyl-3-hydroxybutyrate (CAS Reg. No. |
| 14433-76-2) | 53605-94-0) |
| Diethylene Glycol (CAS Reg. No. 111-46-6) | n-Decyl alcohol (CAS Reg. No. 112-30-1) |
| Diethylene glycol mono butyl ether (CAS | n-Hexyl alcohol (CAS Reg. No. 111-27-3) |
| Reg. No. 112-34-5) | |
| Diethylene Glycol MonoEthyl Ether (CAS | N-Methylpyrrolidone (CAS Reg. No. 872- |
| Reg. No. 111-90-0) | 504) |
| Diethylphthalate | n-Octyl alcohol (CAS Reg. No. 111-87-5) |
| Diisopropyl adipate (CAS Reg. No. 6938-94-9) | n-Propanol |
| Dimethyl adipate (CAS Reg. No. 627-93-0) | Octanamide, N,N-dimethyl (CAS Reg. No. |
| | 1118-92-9) |
| Dimethyl glutarate (CAS Reg. No. 1119-40-0) | Oxo-decyl acetate (CAS Reg. No. 108419-33-6) |
| Dimethyl succinate (CAS Reg. No. 106-65-0) | Oxo-heptyl acetate (CAS Reg. No. 90438-79-2) |
| Dimethyl sulfoxide (CAS No. 67-68-5) | Oxo-hexyl acetate (CAS Reg. No. 88230-35-7) |
| Di-n-butyl carbonate (CAS Reg. No. 542-52-9) | Oxo-nonyl acetate (CAS Reg. No. 108419-34-7) |
| Dipropylene glycol | Oxo-octyl acetate (CAS Reg. No. 108419-32-5) |
| Distillates, (Fishcher-Tropsch), heavy, C₁₈- | Oxo-tridecyl acetate (CAS Reg. No. 108419-35-8) |
| C₅₀, branched, cyclic and linear (CAS | |
| Reg. No. 848301-69-9) | |
| d-Limonene (CAS Reg. No. 5989-27-5) | Petroleum hydrocarbons, light odorless |
| | conforming to 21 CFR 172.884 |
| Edible fats and oils | Phenol |
| Ethyl acetate | Propanoic acid, 2-methyl-, monoester with |
| | 2,2,4-trimethyl-1,3-pentanediol (CAS |
| | Reg. No. 25265-77-4) |
| Ethyl alcohol | Propylene glycol |
| Ethyl esters of fatty acids derived from | Propylene glycol monomethyl ether (CAS |
| edible fats and oils | No. 107-98-2) |
| Ethylene glycol (CAS Reg. No. 107-21-1) | Soybean oil-derived fatty acids |
| Glycerol mono-, di-, and triacetate | Tall oil fatty acid (CAS Reg. No. 61790-12-3) |
| Hydrochloric acid | Tetraethylene glycol (CAS Reg. No. 112-60-7) |
| Isobornyl acetate | Toluenesulfonic acid |
| Isobutyl Acetate (CAS Reg. No. 110-19-0) | Triacetin (glyceryl triacetate) |
| Isobutyl isobutyrate (CAS Reg. No. 97-85-8) | Xylene |
| Isobutyric Acid (CAS Reg. No. 79-31-2) | γ-Butyrolactone |
| Isopropyl myristate (CAS Reg. No. 110-27-0) | |

In some embodiments, the organic solvent is relatively free of water. In some embodiments, the organic solvent contains less than about 10% w/w, about 9% w/w, about 8% w/w, about 7% w/w, about 6% w/w, about 5% w/w, about 4% w/w, about 3% w/w, about 2% w/w, about 1% w/w, about 0.9% w/w, about 0.8% w/w, about 0.7% w/w, about 0.6% w/w, about 0.5% w/w, about 0.4% w/w, about 0.3% w/w, or less than about 0.1% w/w of water based on the total weight of the solvent.

In some embodiments, the organic solvent is a liquid at 20° C. In other embodiments, the organic solvent is a solid at 20° C.

In some embodiments, the solvent is a sulfone. A sulfone solvent can be, but is not limited to, sulfolane, methyl sulfolane (3-methyl sulfolane), and dimethylsulfone. Sulfones, in contrast to sulfoxide and ester solvents, were found to possess better solvent properties and improved handling safety characteristics. In some embodiments, the sulfone is a liquid at 20° C. In some embodiments, the sulfone is a solid at 20° C.

In some embodiments, the solvent is an ether-polyol. An ether-polyol solvent can be, but is not limited to, polyethylene glycols, polypropylene glycols, polyalkylene glycols, and related compounds. In some embodiments, a polypropylene glycol has three terminal alcohols. Exemplary polypropylene glycols having three terminal alcohols, known as propoxylated glycerol, include Dow PT250 (which is a glyceryl ether polymer containing three terminal hydroxyl groups with a molecular weight of 250) and Dow PT700 (which is a glyceryl ether polymer containing three terminal hydroxyl groups with a molecular weight of 700). In some embodiments, ether-polyol comprises a polyethylene or a polypropylene glycol in the molecular weight range of between about 200 and about 10,000 Da. It has been found, for example, that for nitrification inhibitor nitrapyrin when complexed with a polyanion that such nitrapyrin complex compositions containing ether-polyols are more suitable for formation of higher solids and/or actives content than previously described compositions containing esters. In some embodiments, the ether-polyol is a liquid at 20° C. In some embodiments, the ether-polyol is a solid at 20° C.

In some embodiments, an organic solvent can be, but is not limited to, an aromatic solvent such as, but not limited to, alkyl substituted benzene, xylene, propylbenzene, mixed naphthalene and alkyl naphthalene, and mineral oils; kerosene; dialkyl amides of fatty acids, including, but not limited to, dimethylamides of fatty acids, dimethyl amide of caprylic acid; chlorinated aliphatic and aromatic hydrocarbons, including, but not limited to, 1,1,1-trichloroethane, chlorobenzene, esters of glycol derivatives, n-butyl, ethyl, or methyl ether of diethyleneglycol and acetate of the methyl ether of dipropylene glycol; ketones, including, but not limited to, isophorone and trimethylcyclohexanone (dihydroisophorone); and acetate, including, but not limited to, hexyl and heptyl acetate.

In some embodiments, an organic solvent can be, but is not limited to, aromatic 100 (CAS Reg. No. 64742-95-6), aromatic 200 (CAS Reg. No. 64742 94 5), sulfone, glycol, polyglycol, dipropylene glycol, Dow PT250, Dow PT700, PT250, triethylene glycol, tripropylene glycol, propylene carbonate, triacetin, Agnique® AMD 810 (C8-C10 fatty acid dimethyl amides; CAS Numbers 1118-92-9 and 14433-76-2), Rhodiasolv® ADMA 10 (N,N-Dimethyldecanamide, CAS Number 14433-76-2), Rhodiasolv® ADMA 810 (blend of N′N-dimethyloctanamide and N,N-dimethyldecanamide; CAS Numbers 1118-92-9/14433-76-2), Agnique® AMD 3L (N,N-dimethylactamide; CAS Number 35123-06-9), Rhodiasolv® Polarclean (Methyl-5-(dimethylamino)-2-methyl-5-oxopentanoate, CAS Number 1174627-68-9), or mixtures thereof. In some embodiments, the organic solvent is selected from Agnique® AMD 810, Agnique® AMD 3L, Rhodiasolv® ADMA 10, Rhodiasol® ADMA 810, Rhodiasol® Polarclean, and mixtures thereof.

In some embodiments, nitrification inhibitors can be formulated with two different solvent types. In some embodiments, these nitrification inhibitors are complexed with a polyanion. Such nitrification inhibitors and/or complexes thereof formulated in two different solvent types can exhibit high solvation, relative lack of volatility, and suitable environmental and toxicological profiles. The two different solvent types can be selected from two different sulfones, two different ether-polyols, or a sulfone and an ether-polyol. In some embodiments, solvency of the nitrification inhibitor (e.g., nitrapyrin) in solution/solvent at 20° C. is greater than 15% w/w (nitrification inhibitor to total weight), for example from about 15% w/w to about 22% w/w, or about 17% to about 21% w/w, or greater than 16% w/w, greater than 17% w/w, greater than 18% w/w, greater than 19% w/w, greater than 20% w/w, greater than 21% w/w, greater than 22% w/w, greater than 23% w/w, greater than 24% w/w, or greater than 25% w/w greater than 26% w/w, greater than 27% w/w, greater than 28% w/w, greater than 29% w/w, greater than 30% w/w, greater than 35% w/w, greater than 40% w/w, or greater than 45% w/w.

The solvent can be present in the composition at an amount from 0.1% w/v to about 99.9% w/v. In some embodiments, the amount of solvent will be minimized as the amount of nitrification inhibitor and/or complex thereof and/or fungicides maximized. In some embodiments, the amount of solvent is less than 80% w/v, less than 79% w/v, less than 78% w/v, less than 77% w/v, less than 76% w/v, less than 75% w/v, less than 74% w/v less than 73% w/v, less than 72% w/v, less than 71% w/v, less than 70% w/v, less than 65% w/v, less than 60% w/v, or less than 55% w/v. In embodiments, the amount of solvent is from 55% w/v to about 98% w/v; or from about 60% w/v to about 97% w/v; or from about 61% w/v to about 95% w/v; or from about 62% w/v to about 90% w/v; or from about 63% w/v to about 85% w/v; or from about 64% w/v to about 80% w/v. In some embodiments, the amount of solvent is from about 10% w/v to about 90% w/v, from about 20% w/v to about 80% w/v, from about 50% w/v to about 70% w/v, or from about 60% w/v to about 70% w/v.

In some embodiments, the compositions as disclosed herein provide improved loading concentrations of the nitrification inhibitor. In some embodiments, the composition comprises nitrification inhibitors such as nitrapyrin in the form of a complex. Advantageously, nitrapyrin complexes with polyanions have been found to provide excellent loading heretofore not disclosed. Advantages of the highly concentrated compositions include lower cost of shipping and ease of handling. In some embodiments, the composition comprises a nitrification inhibitor such as nitrapyrin in a range of from about 20% to about 50% by wt. based on the total weight of the composition. In some embodiments, the composition comprises nitrapyrin in a range from about 20% to about 40% by wt. based on the total weight of the composition. In some embodiments, the composition comprises nitrapyrin in a range from about 20% to about 35% by wt. based on the total weight of the composition. In some embodiments, the composition comprises nitrapyrin in a range from about 10% to about 20% by wt. based on the total weight of the composition. In some embodiments, the composition comprises nitrapyrin in a range from about 20% to about 30% by wt. based on the total weight of the composition. In some embodiments, the composition comprises nitrapyrin in a range from about 22% to about 28% by wt. based on the total weight of the composition. In some embodiments, the composition comprises nitrapyrin in a range from about 25% to about 30% by wt. based on the total weight of the composition. In some embodiments, the composition comprises nitrapyrin in a range from about 22% to about 26% by wt. based on the total weight of the composition. In some embodiments, the composition comprises nitrapyrin in a range from about 27% to about 32% by wt. based on the total weight of the composition. In some embodiments, the composition comprises nitrapyrin in a range from about 24% to about 30% by wt. based on the total weight of the composition. In some embodiments, the composition comprises nitrapyrin in an amount of about 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by wt. based on the total weight of the composition. Concentration and/or loading of the nitrification inhibitor can vary and a skilled artisan would be able to optimize the concentration/loading of the nitrification inhibitor and/or fungicide accordingly.

In some embodiments, the composition comprises nitrapyrin complexed with one or more polyanion(s). The amount of the polyanion(s) can vary. In some embodiments, the amount of polyanion(s) present in the composition ranges from about 0.01% to about 20% by, from about 0.01 to about 15%, from about 5% to about 12%, from about 5 to about 9%, from about 8 to about 12%, or from about 7% to about 11% based on the total weight of the composition. In some embodiments, the amount of polyanion(s) present in the composition is less than about 20%, about 15%, about 14%, about 13%, about 12%, about 11%, about 10%, about 9%, about 8%, about 7%, about 6%, about 5%, about 4%, about 3%, about 2%, or less than about 1.5% by weight based on the total weight of the composition.

In some embodiments, compositions containing nitrification inhibitors and polyanions are disclosed. In some embodiments, the nitrification inhibitor and polyanion can form a nitrification inhibitor-polyanion complex (e.g., nitrapyrin complex), which can more readily dissolve in appropriate solvents when compared to nitrification inhibitors (e.g., nitrapyrin) alone or with prior art formulations. For example, nitrapyrin complexes with polyanions can form solutions that are greater than or equal to 25% nitrapyrin by weight. Suitable solvents for solvating nitrification inhibitors with polyanions include, but are not limited to, aromatic 100 (CAS Reg. No. 64742-95-6), aromatic 200 (CAS Reg. No. 64742-94-5), sulfones, and glycols.

In some embodiments, compositions comprising a nitrification inhibitor and polyanion and complexes as disclosed herein, e.g., a nitrapyrin complex with a polyanion, can reduce the volatility of the nitrification inhibitor, such as nitrapyrin, by about 5% to about 40% relative to the untreated nitrification inhibitor (e.g., nitrapyrin that is not complexed with a polyanion). In some embodiments, the nitrification inhibitor, such as nitrapyrin, complexed with a polyanion and compositions comprising the complexes reduce volatility of the nitrification inhibitor, e.g., nitrapyrin, by about 8% to about 35% relative to untreated nitrification inhibitor, e.g., nitrapyrin. In some embodiments, the nitrification inhibitor complexed with a polyanion and compositions comprising the complexes reduce volatility of the nitrification inhibitor by about 10% to about 30% relative to untreated nitrification inhibitor. In some embodiments, the nitrification inhibitor complexed with a polyanion and compositions comprising the complexes reduce volatility of the nitrification inhibitor by about 5, 6, 7, 8, 9, 10, 11, 12, 13, 14, 15, 16, 17, 18, 19, 20, 21, 22, 23, 24, 25, 26, 27, 28, or 29% relative to untreated nitrification inhibitor.

In some embodiments, the composition comprises a nitrification inhibitor and a non-polymeric molecule and any complexes thereof (e.g., nitrapyrin complexed with a non-polymeric molecule) having a plurality of anionic functional groups such as carboxylates (i.e., acids). In some embodiments, such composition comprises a solvent. Exemplary solvent-nitrification inhibitor-non-polymeric polyanion combinations and/or complexes thereof include, but are not limited to: one or more of malic acid, tartaric acid, etidronic acid, succinic acid, adipic acid, sebacic acid, isophthalic acid, and one or more of dipropylene glycol, PT700, PT250, triethylene glycol, tripropylene glycol, propylene carbonate, triacetin, Agnique® AMD 810, Agnique® AMD 3L, Rhodiasolv® ADMA 10, Rhodiasolv® ADMA 810, and/or Rhodiasolv® Polarclean. In some embodiments, the composition comprises the following solvent-nitrification inhibitor-non-polymeric polyanion combinations and/or complexes thereof include, but are not limited to: one or more of malic acid, tartaric acid, etidronic acid, succinic acid, and/or adipic acid, and one or more of Agnique® AMD 810, Agnique® AMD 3L, Rhodiasolv® ADMA 10, Rhodiasolv® ADMA 810, and/or Rhodiasolv® Polarclean. In some embodiments, the composition comprises the following solvent-nitrification inhibitor-non-polyanionic polyanion combinations and/or complexes thereof: one or more of sebacic acid and adipic acid; and one or more of Agnique® AMD 3L, Rhodiasolv® ADMA 810, and/or Rhodiasolv® Polarclean. In some embodiments, the nitrification inhibitor is nitrapyrin.

In some embodiments, the composition comprises a nitrification inhibitor and a polymeric polyanion and/or complexes thereof as disclosed herein. In some embodiments, such composition comprises a solvent. Exemplary solvent-nitrification inhibitor-polymeric polyanion combinations include, but are not limited to, maleic-acrylic copolymer, BC and/or T5 copolymer, and one or more of dipropylene glycol, PT700, PT250, triethylene glycol, tripropylene glycol, propylene carbonate, triacetin, Agnique® AMD 810, Agnique® AMD 3L, Rhodiasolv® ADMA 10, Rhodiasolv® ADMA 810, and/or Rhodiasolv® Polarclean. In some embodiments, the composition comprises the following solvent-nitrification inhibitor-polymeric polyanion and/or complexes thereof combinations: T5 tetrapolymer and one or more of Agnique® AMD 3L, Rhodiasolv® ADMA 810, and/or Rhodiasolv® Polarclean In some embodiments, the T5 tetrapolymer is salt. In some embodiments, the T5 tetrapolymer is in a full or partial salt form. Exemplary salt forms include, but are not limited to, sodium, potassium, calcium, magnesium, lithium, and/or cesium. In some embodiments, the nitrification inhibitor is nitrapyrin.

In some embodiments, the composition comprises a fungicide present in an amount of from about 0.01% to about 45% w/w of the composition, a nitrification inhibitor present in an amount of from about 0.01 to about 30% w/w of the composition, a polyanion present in an amount of from about 0.01% to about 15% w/w of the composition, and an organic solvent present in an amount of from about 10% to about 99.97% w/w of the composition.

In some embodiments, the composition comprises a fungicide present in an amount of from about 0.5 to about 1.5% w/w/of the composition, a nitrification inhibitor present in an amount of from about 23% to about 30% w/w of the composition, a polyanion present in an amount of from about 5% to about 12% w/w, and an organic solvent present in an amount of from about 58% to about 70% w/w of the composition. In some embodiments, the fungicide and nitrification inhibitor are present in a weight ratio of about 1:24 of fungicide to nitrification inhibitor.

In some embodiments, the composition comprises thiram present in an amount of from about 0.5 to about 5% w/w of the composition, nitrapyrin present in an amount of from about 10% to about 20% w/w of the composition, adipic acid present in an amount of from about 8% to about 12% w/w, and Rhodiasolv® Polarclean present in an amount of from about 63% to about 81.5% of the composition.

In some embodiments, the composition comprises thiram present in an amount of from about 0.5 to about 5% w/w of the composition, nitrapyrin present in an amount of from about 10% to about 20% w/w of the composition, adipic acid and polyanionic T5 polymer present in an amount of from about 8% to about 12% w/w, and Rhodiasolv® Polarclean present in an amount of from about 63% to about 81.5% w/w of the composition.

In some embodiments, the composition comprises thiram present in an amount of from about 0.5 to about 5% w/w of the composition, nitrapyrin present in an amount of from about 10% to about 20% w/w of the composition, adipic acid and polyanionic T5 polymer present in an amount of from about 5% to about 9% w/w, and Agnique® AMD 3L present in an amount of from about 66% to about 84.5% w/w of the composition.

In some embodiments, the composition comprises thiram present in an amount of from about 0.5 to about 5% w/w of the composition, nitrapyrin present in an amount of from about 10% to about 20% w/w of the composition, adipic acid and polyanionic T5 polymer present in an amount of from about 5% to about 9% w/w, and Agnique® AMD 3L present in an amount of from about 66% to about 84.5% w/w of the composition.

In some embodiments, formulations are disclosed that contain the compositions of the invention and one or more co-formulants. Exemplary co-formulants include, but are not limited to, any co-formulant known in the art such as solvents, surface active ingredients, carriers, wetting agents, emulsifiers, anti-foaming agents, preservatives, dyes, etc.

### III. AGRICULTURAL PRODUCTS

Any of the described compositions disclosed herein can be combined with one or more other ingredients, selected from the group consisting of fertilizer, agriculturally active compounds, seed, compounds having urease inhibition activity, nitrification inhibition activity, pesticides, herbicides, insecticides, fungicides, miticides, and the like.

In some embodiments, the described composition may be mixed with the fertilizer products, applied as a surface coating to the fertilizer products, or otherwise thoroughly mixed with the fertilizer products. In some embodiments, in such combined agricultural compositions, the fertilizer is in the form of particles having an average diameter of from about powder size (less than about 0.001 cm) to about 10 mm, more preferably from about 0.1 mm to about 5 mm, and still more preferably from about 0.15 mm to about 3 mm. The composition of the invention can be present in such combined agricultural compositions at a level of about 0.001 g to about 20 g per 100 g fertilizer, about 0.01 to 7 g per 100 g fertilizer, about 0.08 g to about 5 g per 100 g fertilizer, or about 0.09 g to about 2 g per 100 g fertilizer. In the case of the combined fertilizer/composition agricultural products, the combined agricultural composition can be applied at a level so that the amount of the composition of the invention applied is about 10-150 g per acre of soil, about 30-125 g per acre, or about 40-120 g per acre of soil. The combined agricultural composition can likewise be applied as liquid dispersions or as dry granulated products, at the discretion of the user. When the composition of the invention is used as a coating, the agricultural composition can comprise between about 0.005% and about 15% by weight of the coated fertilizer product, about 0.01% and about 10% by weight of the coated fertilizer product, about 0.05% and about 2% by weight of the coated fertilizer product or about 0.5% and about 1% by weight of the coated fertilizer product.

A. Fertilizers

In some embodiments, the agricultural product is a fertilizer. The fertilizer can be a solid fertilizer, such as, but not limited to, a granular fertilizer, and the composition of the invention can be applied to the fertilizer as a liquid dispersion. The fertilizer can be in liquid form, and the composition of the invention can be mixed with the liquid fertilizer. The fertilizers can be selected from the group consisting of starter fertilizers, phosphate-based fertilizers, fertilizers containing nitrogen, fertilizers containing phosphorus, fertilizers containing potassium, fertilizers containing calcium, fertilizers containing magnesium, fertilizers containing boron, fertilizers containing chlorine, fertilizers containing zinc, fertilizers containing manganese, fertilizers containing copper, fertilizers containing urea and ammonium nitrite, and/or fertilizers containing molybdenum materials. In some embodiments, the fertilizer is or contains urea, and/or ammonia, including anhydrous ammonia fertilizer. In some embodiments, the fertilizer comprises plant-available nitrogen, phosphorous, potassium, sulfur, calcium, magnesium, or micronutrients. In some embodiments, the fertilizer is solid, granular, a fluid suspension, a gas, or a solutionized fertilizer. In some embodiments, the fertilizer comprises a micronutrient. A micronutrient is an essential element required by a plant in small quantities. In some embodiments, the fertilizer comprises a metal ion selected from the group consisting of: Fe, Mn, Mg, Zn, Cu, Ni, Co, Mo, V, and Ca. In some embodiments, the fertilizer comprises gypsum, Kieserite Group member, potassium product, potassium magnesium sulfate, elemental sulfur, or potassium magnesium sulfate. Such fertilizers may be granular, liquid, gaseous, or mixtures (e.g., suspensions of solid fertilizer particles in liquid material).

In some embodiments, the composition of the invention is combined with any suitable liquid or dry fertilizer for application to fields and/or crops.

The described composition of the invention can be applied with the application of a fertilizer. The composition of the invention can be applied prior to, subsequent to, or simultaneously with the application of fertilizers.

Fertilizer compositions containing the composition of the invention can be applied in any manner which will benefit the crop of interest. In some embodiments, a fertilizer composition is applied to growth mediums in a band or row application. In some embodiments, the compositions are applied to or throughout the growth medium prior to seeding or transplanting the desired crop plant. In some embodiments, the compositions can be applied to the root zone of growing plants.

B. Seed

Some embodiments describe agricultural seeds coated with one or more of the described compositions of the invention. The composition of the invention can be present in the seed product at a level of from about 0.001-10%, about 0.004%-2%, about 0.01% to about 1%, or from about 0.1% to about 1% by weight (or no more than about 10%, about 9%, about 8%, about 7% about 6%, about 5%, about 4%, about 3%, about 2%, about 1%, about 0.5%, about 0.1%, about 0.01% or no more than 0.001%), based upon the total weight of the coated seed product. A seed can be, but is not limited to, wheat, barley, oat, triticale, rye, rice, maize, soya bean, cotton, or oilseed rape.

C. Other

Some embodiments describe urease-inhibiting compounds, nitrification inhibiting compounds, pesticides, herbicides, insecticides, and/or miticides in combination with one or more of the described compositions of the invention. As used herein, “pesticide” refers to any agent with pesticidal activity (e.g., herbicides, insecticides) and is preferably selected from the group consisting of insecticides, herbicides, and mixtures thereof, but normally excluding materials which assertedly have plant-fertilizing effect, for example sodium borate and zinc compounds such as zinc oxide, zinc sulfate, and zinc chloride. For an unlimited list of pesticides, see “Farm Chemicals Handbook 2000, 2004” (Meister Publishing Co, Willoughby, Ohio), which is hereby incorporated by reference in its entirety.

Exemplary herbicides include, but are not limited to, acetochlor, alachlor, aminopyralid, atrazine, benoxacor, bromoxynil, carfentrazone, chlorsulfuron, clodinafop, clopyralid, dicamba, diclofop-methyl, dimethenamid, fenoxaprop, flucarbazone, flufenacet, flumetsulam, flumiclorac, fluroxypyr, glufosinate-ammonium, glyphosate, halosulfuron-methyl, imazamethabenz, imazamox, imazapyr, imazaquin, imazethapyr, isoxaflutole, quinclorac, MCPA, MCP amine, MCP ester, mefenoxam, mesotrione, metolachlor, s-metolachlor, metribuzin, metsulfuron methyl, nicosulfuron, paraquat, pendimethalin, picloram, primisulfuron, propoxycarbazone, prosulfuron, pyraflufen ethyl, rimsulfuron, simazine, sulfosulfuron, thifensulfuron, topramezone, tralkoxydim, triallate, triasulfuron, tribenuron, triclopyr, trifluralin, 2,4-D, 2,4-D amine, 2,4-D ester and the like.

Exemplary insecticides include, but are not limited to, 1,2 dichloropropane, 1,3 dichloropropene, abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate, barium hexafluorosilicate, barthrin, benclothiaz, bendiocarb, benfuracarb, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A & B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate, d-limonene, dazomet, DBCP, DCIP, DDT, decarbofuran, deltamethrin, demephion, demephion O, demephion S, demeton, demeton methyl, demeton O, demeton 0 methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfiram, disulfoton, dithicrofos, DNOC, dofenapyn, doramectin, ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD, famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, furathiocarb, furethrin, furfural, gamma cyhalothrin, gamma HCH, halfenprox, halofenozide, HCH, HEOD, heptachlor, heptenophos, heterophos, hexaflumuron, hexythiazox, HHDN, hydramethylnon, hydrogen cyanide, hydroprene, hyquincarb, imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin jasmolin I, jasmolin II, jodfenphos, juvenile hormone I, juvenile hormone II, juvenile hormone III, kelevan, kinoprene, lambda cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin, naftalofos, naled, naphthalene, nicotine, nifluridide, nikkomycins, nitenpyram, nithiazine, nitrilacarb, novaluron, noviflumuron, omethoate, oxamyl, oxydemeton methyl, oxydeprofos, oxydisulfoton, paradichlorobenzene, parathion, parathion methyl, penfluron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen, quassia, quinalphos, quinalphos, quinalphos methyl, quinothion, quantifies, rafoxanide, resmethrin, rotenone, ryania, sabadilla, schradan, selamectin, silafluofen, sodium arsenite, sodium fluoride, sodium hexafluorosilicate, sodium thiocyanate, sophamide, spinetoram, spinosad, spirodiclofen, spiromesifen, spirotetramat, sulcofuron, sulfiram, sulfluramid, sulfotep, sulfur, sulfuryl fluoride, sulprofos, tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thiamethoxam, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene, vamidothion, vaniliprole, vaniliprole, XMC, xylylcarb, zeta cypermethrin and zolaprofos.

Exemplary classes of miticides include, but are not limited to, botanical acaricides, bridged diphenyl acaricides, carbamate acaricides, oxime carbamate acaricides, carbazate acaricides, dinitrophenol acaricides, formamidine acaricides, isoxaline acaricides, macrocyclic lactone acaricides, avermectin acaricides, milbemycin acaricides, milbemycin acaricides, mite growth regulators, organochlorine acaricides, organophosphate acaricides, organothiophosphate acaricides, phosphonate acaricides, phosphoarmidothiolate acaricies, organitin acaricides, phenylsulfonamide acaricides, pyrazolecarboxamide acaricdes, pyrethroid ether acaricide, quaternary ammonium acaricides, oyrethroid ester acaricides, pyrrole acaricides, quinoxaline acaricides, methoxyacrylate strobilurin acaricides, teronic acid acaricides, thiasolidine acaricides, thiocarbamate acaricides, thiourea acaricides, and unclassified acaricides. Examples of miticides for these classes include, but are not limited to, to botanical acaricides—carvacrol, sanguinarine; bridged diphenyl acaricides—azobenzene, benzoximate, benzyl, benzoate, bromopropylate, chlorbenside, chlorfenethol, chlorfenson, chlorfensulphide, chlorobenzilate, chloropropylate, cyflumetofen, DDT, dicofol, diphenyl, sulfone, dofenapyn, fenson, fentrifanil, fluorbenside, genit, hexachlorophene, phenproxide, proclonol, tetradifon, tetrasul; carbamate acaricides—benomyl, carbanolate, carbaryl, carbofuran, methiocarb, metolcarb, promacyl, propoxur; oxime carbamate acaricides—aldicarb, butocarboxim, oxamyl, thiocarboxime, thiofanox; carbazate acaricides—bifenazate; dinitrophenol acaricides—binapacryl, dinex, dinobuton, dinocap, dinocap-4, dinocap-6, dinocton, dinopenton, dinosulfon, dinoterbon, DNOC; formamidine acaricides—amitraz, chlordimeform, chloromebuform, formetanate, formparanate, medimeform, semiamitraz; isoxazoline acaricides—afoxolaner, fluralaner, lotilaner, sarolaner; macrocyclic lactone acaricides—tetranactin; avermectin acaricides—abamectin, doramectin, eprinomectin, ivermectin, selamectin; milbemycin acaricides—milbemectin, milbemycin, oxime, moxidectin; mite growth regulators—clofentezine, cyromazine, diflovidazin, dofenapyn, fluazuron, flubenzimine, flucycloxuron, flufenoxuron, hexythiazox; organochlorine acaricides—bromociclen, camphechlor, DDT, dienochlor, endosulfan, lindane; organophosphate acaricides—chlorfenvinphos, crotoxyphos, dichlorvos, heptenophos, mevinphos, monocrotophos, naled, TEPP, tetrachlorvinphos; organothiophosphate acaricides—amidithion, amiton, azinphos-ethyl, azinphos-methyl, azothoate, benoxafos, bromophos, bromophos-ethyl, carbophenothion, chlorpyrifos, chlorthiophos, coumaphos, cyanthoate, demeton, demeton-O, demeton-S, demeton-methyl, demeton-O-methyl, demeton-S-methyl, demeton-S-methylsulphon, dialifos, diazinon, dimethoate, dioxathion, disulfoton, endothion, ethion, ethoate-methyl, formothion, malathion, mecarbam, methacrifos, omethoate, oxydeprofos, oxydisulfoton, parathion, phenkapton, phorate, phosalone, phosmet, phostin, phoxim, pirimiphos-methyl, prothidathion, prothoate, pyrimitate, quinalphos, quintiofos, sophamide, sulfotep, thiometon, triazophos, trifenofos, vamidothion; phosphonate acaricides—trichlorfon; phosphoramidothioate acaricides—isocarbophos, methamidophos, propetamphos; phosphorodiamide acaricides—dimefox, mipafox, schradan; organotin acaricides—azocyclotin, cyhexatin, fenbutatin, oxide, phostin; phenylsulfamide acaricides—dichlofluanid; phthalimide acaricides—dialifos, phosmet; pyrazole acaricides—cyenopyrafen, fenpyroximate; phenylpyrazole acaricides—acetoprole, fipronil, vaniliprole; pyrazolecarboxamide acaricides—pyflubumide, tebufenpyrad; pyrethroid ester acaricides—acrinathrin, bifenthrin, brofluthrinate, cyhalothrin, cypermethrin, alpha-cypermethrin, fenpropathrin, fenvalerate, flucythrinate, flumethrin, fluvalinate, tau-fluvalinate, permethrin; pyrethroid ether acaricides—halfenprox; pyrimidinamine acaricides—pyrimidifen; pyrrole acaricides—chlorfenapyr; quaternary ammonium acaricides—sanguinarine; quinoxaline acaricides—chinomethionat, thioquinox; methoxyacrylate strobilurin acaricides—bifujunzhi, fluacrypyrim, flufenoxystrobin, pyriminostrobin; sulfite ester acaricides—aramite, propargite; tetronic acid acaricides—spirodiclofen; tetrazine acaricides, clofentezine, diflovidazin; thiazolidine acaricides—flubenzimine, hexythiazox; thiocarbamate acaricides—fenothiocarb; thiourea acaricides—chloromethiuron, diafenthiuron; unclassified acaricides—acequinocyl, acynonapyr, amidoflumet, arsenous, oxide, clenpirin, closantel, crotamiton, cycloprate, cymiazole, disulfiram, etoxazole, fenazaflor, fenazaquin, fluenetil, mesulfen, MNAF, nifluridide, nikkomycins, pyridaben, sulfiram, sulfluramid, sulfur, thuringiensin, triarathene.

In some embodiments, a miticide can also be selected from abamectin, acephate, acequinocyl, acetamiprid, aldicarb, allethrin, aluminum phosphide, aminocarb, amitraz, azadiractin, azinphos-ethyl, azinphos-methyl, Bacillus thuringiensis, bendiocarb, beta-cyfluthrin, bifenazate, bifenthrin, bomyl, buprofezin, calcium cyanide, carbaryl, carbofuran, carbon disulfide, carbon tetrachloride, chlorfenvinphos, chlorobenzilate, chloropicrin, chlorpyrifos, clofentezine, chlorfenapyr, clothianidin, coumaphos, crotoxyphos, crotoxyphos+dichlorvos, cryolite, cyfluthrin, cyromazine, cypermethrin, deet, deltamethrin, demeton, diazinon, dichlofenthion, dichloropropene, dichlorvos, dicofol, dicrotophos, dieldrin, dienochlor, diflubenzuron, dikar (fungicide+miticide), dimethoate, dinocap, dinotefuran, dioxathion, disulfoton, emamectin benzoate, endosulfan, endrin, esfenvalerate, ethion, ethoprop, ethylene dibromide, ethylene dichloride, etoxazole, famphur, fenitrothion, fenoxycarb, fenpropathrin, fenpyroximate, fensulfothion, fenthion, fenvalerate, flonicamid, flucythrinate, fluvalinate, fonofos, formetanate hydrochloride, gamma-cyhalothrin, halofenozide, hexakis, hexythiazox, hydramethylnon, hydrated lime, indoxacarb, imidacloprid, kerosene, kinoprene, lambda-cyhalothrin, lead arsenate, lindane, malathion, mephosfolan, metaldehyde, metam-sodium, methamidophos, methidathion, methiocarb, methomyl, methoprene, methoxychlor, methoxyfenozide, methyl bromide, methyl parathion, mevinphos, mexacarbate, Milky Disease Spores, naled, naphthalene, nicotine sulfate, novaluron, oxamyl, oxydemeton-methyl, oxythioquinox, para-dichlorobenzene, parathion, PCP, permethrin, petroleum oils, phorate, phosalone, phosfolan, phosmet, phosphamidon, phoxim, piperonyl butoxide, pirimicarb, pirimiphos-methyl, profenofos, propargite, propetamphos, propoxur, pymetrozine, pyrethroids—synthetic: see allethrin, permethrin, fenvalerate, resmethrin, pyrethrum, pyridaben, pyriproxyfen, resmethrin, rotenone, s-methoprene, soap, pesticidal, sodium fluoride, spinosad, spiromesifen, sulfotep, sulprofos, temephos, terbufos, tetrachlorvinphos, tetrachlorvinphos+dichlorvos, tetradifon, thiamethoxam, thiodicarb, toxaphene, tralomethrin, trimethacarb, and tebufenozide.

In some embodiments, the composition of the presently disclosed subject matter is a pesticide/fungicide/nitrification inhibitor-containing composition comprising a pesticide, a fungicide, and a nitrification inhibitor as disclosed herein. In some embodiments, the pesticide is an herbicide, insecticide, miticide, or a combination thereof.

### IV. METHODS

In some embodiments, the compositions disclosed herein are used directly. In other embodiments, the compositions disclosed herein are formulated in ways to make their use convenient in the context of productive agriculture. The compositions used in these methods include the compositions as described above. Such compositions can be used in methods such as:
A. Methods of Improving Plant Growth and/or Fertilizing Soil
B. Methods of Inhibiting Nitrification or Ammonia Release or Evolution
C. Methods of Improving Soil Conditions

A. Methods for improving plant growth comprise contacting a composition or an agricultural formulation thereof containing a fungicide and nitrification inhibitor as disclosed herein with soil. In some embodiments, the composition or an agricultural formulation thereof is applied to the soil prior to emergence of a planted crop. In some embodiments, the composition or an agricultural formulation thereof is applied to the soil post emergence of a planted crop. In some embodiments, the composition or an agricultural formulation thereof is applied to the soil adjacent to the plant and/or at the base of the plant and/or in the root zone of the plant.

Methods for improving plant growth can also be achieved by applying a composition or an agricultural formulation thereof containing a fungicide and nitrification inhibitor as described herein as a seed coating to a seed in the form of a liquid dispersion which upon drying forms a dry residue. In these embodiments, seed coating provides the composition or an agricultural formulation thereof in close proximity to the seed when planted so that the nitrification inhibitor and fungicide can exert their beneficial effects in the environment where they are most needed. That is, the nitrification inhibitor and fungicide provide an environment conducive to enhanced plant growth in the area where the effects can be localized around the desired plant. In the case of seeds, the coating containing the nitrification inhibitor and fungicide provides an enhanced opportunity for seed germination, subsequent plant growth, and an increase in plant nutrient availability.

B. Methods for inhibiting/reducing nitrification or ammonia release or evolution in an affected area comprises applying a composition or agricultural formulation containing a nitrification inhibitor and fungicide to the affected area. The affected area may be soil adjacent to a plant, a field, a pasture, a livestock or poultry confinement facility, pet litter, a manure collection zone, upright walls forming an enclosure, or a roof substantially covering the area, and in such cases the composition may be applied directly to the manure in the collection zone. The composition is preferably applied at a level from about 0.005-3 gallons per ton of manure, in the form of an aqueous dispersion having a pH from about 1-5.

Nitrification in nature is a two-step oxidation process of ammonium (NH₄⁺) or ammonia (NH₃) to nitrate (NO₃⁻) catalyzed by two ubiquitous bacterial groups. The first reaction is oxidation of ammonium to nitrite by ammonia-oxidizing bacteria (AOB) represented by the “Nitrosomonas” genus. The second reaction is oxidation of nitrite (NO₂⁻) to nitrate by nitrite-oxidizing bacteria (NOB), represented by the “Nitrobacter” genus. In some embodiments, the composition and/or agricultural composition of the invention inhibits nitrification by inhibiting an ammonia-oxidizing bacteria (AOB). In some embodiments, the composition and/or agricultural composition inhibits a bacteria of the Nitrosomonas genus. In some embodiments, the composition and/or agricultural composition inhibits Nitrosomonas europaea.

In some embodiments, the nitrification (and/or ammonia-oxidizing bacteria (AOB)) is inhibited from about 10% to about 99%, from about 25% to about 85%, from about 50% to about 75% (or by at least about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or by at least 98%).

In some embodiments, the nitrification (and/or ammonia-oxidizing bacteria (AOB)) is inhibited by from about 10% to about 85%, from about 25% to about 75%, from about 50% to about 75% more (or by at least about 10%, about 15%, about 20%, about 25%, about 30%, about 35%, about 40%, about 45%, about 50%, about 55%, about 60%, about 65%, about 70%, about 75%, about 80%, or by at least 85% more) compared to a nitrification inhibitor-containing composition with no fungicide. Not to be bound by theory, but it is believed that combining a fungicide of the invention with and a nitrification inhibitor of the invention produces a synergistic effect for the inhibiting of nitrification. Therefore, in some embodiments, the oxygen consumption of the ammonia oxidizing bacteria in the presence of the disclosed composition is reduced by about 1% to about 90%, by about 10% to about 90%, by about 20% to about 90%, by about 30% to about 90%, by about 40% to about 95%, by about 50% to about 90%, by about 55% to about 85%, by about 60% to about 80%, or by about 65% to about 80% (or by at least about 35%, about 40%, about 45%, about 50%, about 55%, about 60%, about 65%, about 70%, about 75%, about 80%, about 85%, or at least by about 90%).

Thus, in some embodiments, the nitrification (and/or ammonia-oxidizing bacteria (AOB)) is inhibited when an effective amount of the composition of the invention comprises a synergistically effective amount of fungicide and nitrification inhibitor such that nitrification is inhibited by from about 10% to about 80% compared to the sum of the individual nitrification inhibition of the fungicide and the nitrification inhibitor by itself.

C. Methods for improving soil conditions selected from the group consisting of nitrification processes, urease activities, and combinations thereof, comprising the step of applying to soil an effective amount of a described composition or agricultural formulation containing a nitrification inhibitor and fungicide as disclosed herein. In some embodiments, the composition is mixed with an ammoniacal solid, liquid, or gaseous fertilizer, and especially solid fertilizers; in the latter case, the composition is applied to the surface of the fertilizer as an aqueous dispersion followed by drying, so that the composition is present on the solid fertilizer as a dried residue. The composition is generally applied at a level of from about 0.01-10% by weight, based upon the total weight of the composition/fertilizer product taken as 100% by weight. Where the fertilizer is an aqueous liquid fertilizer, the composition is added thereto with mixing. The composition is preferably in aqueous dispersion and has a pH of up to about 3.

In some embodiments, the methods A, B, and C above comprise contacting a desired area with the disclosed composition at a rate of about 100 g to about 120 g per acre of the nitrification inhibitor. The nitrification inhibitor can, in some embodiments, be in solution at an amount of about 0.5 lbs to about 4 lbs per U.S. gallon, or from about 1 lb to about 3 lbs/per U.S. gallon, or about 2 lbs per U.S. gallon. In some embodiments, the method includes contacting the desired area at a rate of about 0.5 to about 4 qt/A, or about 1 to about 2 qt/A.

Particular embodiments of the subject matter described herein include:

1. A composition comprising:
a fungicide selected from amide-based fungicides, dithiocarbamate-based fungicides, oxazole-containing fungicides, phosphoric acid-derived fungicides, and a combination thereof; and
a nitrification inhibitor selected from S-containing compounds, cyano-containing compounds, N-heterocylic-containing compounds, and a combination thereof.

2. A composition comprising:
a fungicide selected from amide-based fungicides, dithiocarbamate-based fungicides, oxazole-containing fungicides, phosphoric acid-derived fungicides, and a combination thereof;
a nitrification inhibitor selected from S-containing compounds, cyano-containing compounds, N-heterocylic-containing compounds, and a combination thereof, and
a polyanion.

3. The composition of embodiment 1 or 2, wherein the fungicide is an amide-based fungicide selected from acylalanine fungicides (acylamino acid), anilide fungicide, benzanilide fungicide, and a combination thereof.

4. The composition of any above embodiment, wherein the amide-based fungicide is:
(a) an acylalanine (acylamino acid) fungicide selected from benalaxyl, benalaxyl-M, furalaxyl, metalaxyl, metalaxyl-M, and a combination thereof; or
(b) an anilide fungicide selected from boscalid, carboxin, fenhexamid, fluxapyroxad, isotianil, metsulfovax, ofurace, oxycarboxin, penflufen, pyracarbolid, pyraziflumid, sedaxane, thifluzamide, tiadinil, vanguard, benodanil, flutolanil, mebenil, mepronil, salicylanilide, tecloftalam, fenfuram, furcabinil, methfuroxam, and a combination thereof.

5. The composition of any above embodiment, wherein the fungicide is a dithiocarbamate-based fungicide selected from ethylene-(bis)-dithiocarbamates, dimethyldithiocarbamates, monomethyldithiocarbamates, and a combination thereof.

6. The composition of any above embodiment, wherein the dithiocarbamate-based fungicide is:
(a) an ethylene-(bis)-dithiocarbamate (EBDC) selected from mancozeb, maneb, metiram, propineb, zineb, amobam, and a combination thereof; and/or
(b) a dimethyldithiocarbamate (DMDTC) selected from Na-dimethyl-dithiocarbamate, nabam, ziram, ferbam, thiram, asomate, azithiram, carbamorph, disulfiram, tecoram, urbacide, and a combination thereof; and/or
(c) monomethylthiocarbamate (MMDTC) metam sodium.

7. The composition of any above embodiment, wherein the fungicide is an oxazole-containing fungicide selected from famoxadone (3-anilino-5-methyl-5-(4-phenoxyphenyl)-1,3-oxazolidine-2,4-dione), oxadixyl, vinclozolin, myclozolin, dichlozoline, chlozolinate, drazoloxon, fluoxapiprolin, hymexazol, metzoloxon, myclozolin, oxathiapiprolin, pyrisoxazole, and a combination thereof.

8. The composition of any above embodiment, wherein the fungicide is a phosphoric acid-derived fungicide selected from phosphite-containing fungicides, phosphonate-containing fungicides, phosphoric acid-containing fungicides, and salts and any combination thereof.

9. The composition of embodiment 8, wherein the phosphite-containing fungicide is selected from potassium phosphite (mono-, di-), sodium phosphite (mono-, di-), ammonium phosphite (mono-, di-), and a combination thereof; the phosphonate-containing fungicide is selected from ethyl hydrogen phosphonate, aluminum tris(O-ethylphosphonate), potassium phosphonate, and a combination thereof; and the phosphoric acid-derived fungicide is in a salt form selected from potassium, calcium, sodium, cesium, magnesium, and/or ammonium salt.

10. The composition of any above embodiment, wherein the fungicide is selected from metalaxyl, metalaxyl-M, mancozeb, ziram, zineb, thiram, and a combination thereof.

11. The composition of any above embodiment, wherein the nitrification inhibitor is an S-containing compound selected from ammoniumthiosulfate (ATU), 1-amino-2-thiourea (ASU), 2-mercapto-benzothiazole (MBT), 2,4-triazol thiourea (TU), 2-sulfanilamidothiazole (ST), 5-ethoxy-3-trichloromethyl-1,2,4-thiodiazole (terrazole), thiophosphoryl triamide, and a combination thereof.

12. The composition of any above embodiment, wherein the nitrification inhibitor is a cyano-containing compound selected from 2-cyano-1-((4-oxo-1,3,5-triazinan-1-yl)methyl)guanidine,1-((2-cyanoguanidino)methyl)urea, 2-cyano-1-((2-cyanoguanidino)methyl)guanidine, dicyandiamide (DCD), pronitridine, and a combination thereof.

13. The composition of any above embodiment, wherein the nitrification inhibitor is a N-heterocylic compound selected from 2-(3,4-dimethyl-1H-pyrazol-1-yl)succinic acid (DMPSA1), 2-(4,5-dimethyl-1H-pyrazol-1-yl)succinic acid (DMPSA2), 3,4-dimethyl pyrazolium salts, 2,4-triazole (TZ), 4-chloro-3-methylpyrazole (CIMP), N-((3(5)-methyl-1H-pyrazole-1-yl)methyl)acetamide, N-((3(5)-methyl-1H-pyrazole-1-yl)methyl)formamide, N-((3(5),4-dimethylpyrazole-1-yl) methyl)formamide, N-((4-chloro-3(5)-methyl-pyrazole-1-yl)methyl)formamide, 2-chloro-6-(trichloromethyl)-pyridine (nitrapyrin), 3,4-dimethyl pyrazole phosphate (DMPP), 4,5-dimethyl pyrazole phosphate (ENTEC), 3,4-dimethylpyrazole, 4,5-dimethylpyrazole (DMP), 4-amino-1,2,4-triazole hydrochloride (ATC), 2-amino-4-chloro-6-methylpyrimidine (AM), and a combination thereof.

14. The composition of any above embodiment, wherein the nitrification inhibitor is selected from nitrapyrin, DCD, DMPP, pronitridine, and salts and/or combinations thereof.

15. The composition of any above embodiment, wherein the fungicide and nitrification inhibitor are present in a synergistically effective amount.

16. The composition of any above embodiment, wherein the fungicide and the nitrification inhibitor are present in a weight ratio of from about 1:99 to about 99:1.

17. The composition of any above embodiment, wherein the polyanion comprises a non-polymeric polyanion, a polyanionic polymer, or a combination thereof.

18. The composition of embodiment 17, wherein the non-polymeric polyanion comprises a di-, tri-, tetra-, penta-, hexa-, hepta-, octa-, nona-, or deca-carboxyl, a di-, tri-, tetra-, penta-, hexa-, hepta-, octa-, nona-, or deca-sulfonate, or a di-, tri-, tetra-, penta-, hexa-, hepta-, octa-, nona-, or deca-phosphonate.

19. The composition of embodiment 17 or 18, wherein the non-polymeric polyanion is selected from malic acid, tartaric acid, etidronic acid, succinic acid, adipic acid, isophthalic acid, aconitic, trimesic, biphenyl-3,3′,5,5′-tetracarboxylic acid, furantetracarboxylic acid, sebacic acid, azelaic acid, isoterephtalic acid, pyromellitic acid, mellitic acid, and a combination thereof.

20. The composition of embodiment 17, wherein the polyanionic polymer is a terpolymer, a tetrapolymer, or a random copolymer.

21. The composition of embodiment 17 or 20, wherein the polyanionic polymer comprises a random copolymer having at least two repeat units including at least one each of type B and type C repeat unites, and optionally one or more different type G repeat units, wherein:
a) the type B repeat units are independently selected from the group consisting of repeat units derived from substituted and unsubstituted monomers of maleic acid, maleic anhydride, fumaric acid, fumaric anhydride, mesaconic acid, mesaconic, mixtures of the foregoing, and any isomers, esters, acid chlorides, and partial or complete salts of any of the foregoing, wherein type B repeat units may be substituted with one or more C₁-C₆ straight or branched chain alkyl groups substantially free of ring structures and halo atoms, and wherein the salts have salt-forming cations selected from the group consisting of metals, amines, and mixtures thereof;
b) the type C repeat units selected from the group consisting of repeat units derived from substituted or unsubstituted monomers of itaconic acid, itaconic anhydride, and any isomers, esters, and the partial or complete salts of any of the foregoing, and mixtures of any of the foregoing, wherein the type C repeat units may be substituted with one or more C₁-C₆ straight or branched chain alkyl groups substantially free of ring structures and halo atoms, and wherein the salts have salt-forming cations selected from the group consisting of metals, amines, and mixtures thereof; and
c) the type G repeat units selected from the group consisting of repeat units derived from substituted or unsubstituted sulfonated monomers possessing at least one carbon-carbon double bond and at least one sulfonate group and which are substantially free of aromatic rings and amide groups, and any isomers, and the partial or complete salts of any of the foregoing, and mixtures of any of the foregoing, wherein type G repeat units may be substituted with one or more C₁-C₆ straight or branched chain alkyl groups substantially free of ring structures and halo atoms, and wherein the salts of the type G repeat units have salt-forming cations selected from the group consisting of metals, amines, and mixtures thereof,

and wherein at least about 90 mole percent of the repeat units therein are selected from the group consisting of type B, C, and G repeat units, and mixtures thereof, and, wherein the polyanionic polymer contains no more than about 10 mole percent of any of (i) non-carboxylate olefin repeat units, (ii) ether repeat units, and (iii) non-sulfonated monocarboxylic repeat units.

22. The composition of embodiment 21, wherein the polyanionic polymer consists of one type B repeat unit derived from maleic acid, one type C repeat unit derived from itaconic acid, and two type G repeat units respectively derived from methallylsulfonic acid and allylsulfonic acid.

23. The composition of embodiments 17, 20, 21 and 22, wherein the polyanionic polymer is a copolymer consisting of maleic and itaconic repeat units.

24. The composition of any above embodiment, wherein the polyanion comprises adipic acid and a T5 polyanionic polymer having a repeat unit molar composition of 45 mole percent maleic repeat units, 50 mole percent itaconic repeat units, 4 mole percent methallylsulfonate repeat units, and 1 mole percent allylsulfonate repeat units.

25. The composition of any above embodiment, wherein the nitrification inhibitor is complexed with the polyanion.

26. The composition of any above embodiment, further comprising an organic solvent.

27. The composition of embodiment 26, wherein the organic solvent is selected from Agnique® AMD 810, Agnique® AMD 3L, Rhodiasolv® ADMA 10, Rhodiasolv® ADMA 810, and/or Rhodiasolv® Polarclean, and a combination thereof.

28. The composition of embodiments 26 or 27 comprising nitrapyrin, thiram, adipic acid, and an organic solvent selected from Agnique® AMD 3L and Rhodiasolv® Polarclean.

29. The composition of embodiments 17 and 20-23 comprising a polyanionic polymer having a repeat unit molar composition of 45 mole percent maleic repeat units, 50 mole percent itaconic repeat units, 4 mole percent methallylsulfonate repeat units, and 1 mole percent allylsulfonate repeat units.

30. The composition of embodiment 26, 27, and 28, wherein the fungicide is present in an amount of from about 0.01% to about 45% w/w of the composition, the nitrification inhibitor is present in an amount of from about 0.01 to about 30% w/w of the composition, the polyanion is present in an amount of from about 0.01% to about 15% w/w of the composition, and the organic solvent is present in an amount of from about 10% to about 99.97% w/w of the composition.

31. The composition of embodiments 26, 27, 28, and 30, wherein the fungicide is present in an amount of from about 0.5 to about 30% w/w of the composition, the nitrification inhibitor is present in an amount of from about 10% to about 30% w/w of the composition, the polyanion is present in an amount of from about 5% to about 12% w/w, and the organic solvent is present in an amount of from about 28% to about 84.5% w/w of the composition.

32. The composition of any above embodiments, wherein the fungicide and nitrification inhibitor are present in a weight ratio of about 1:24 of fungicide to nitrification inhibitor.

33. The composition of embodiments 26, 27, 28, 30, and 32, wherein thiram is present in an amount of from about 0.5 to about 20% w/w of the composition, nitrapyrin is present in an amount of from about 10% to about 20% w/w of the composition, adipic acid is present in an amount of from about 7% to about 11% w/w, and Rhodiasolv® Polarclean is present in an amount of from about 49% to about 82.5% w/w of the composition.

34. The composition of embodiments 26, 27, 28, 30 and 32, wherein thiram is present in an amount of from about 0.5 to about 5% w/w of the composition, nitrapyrin is present in an amount of from about 10% to about 20% w/w of the composition, adipic acid and polyanionic T5 polymer is present in an amount of from about 8% to about 12% w/w, and Rhodiasolv® Polarclean is present in an amount of from about 63% to about 81.5% w/w of the composition.

35. The composition of embodiments 26, 27, 28, 30 and 32, wherein thiram is present in an amount of from about 0.5 to about 5% w/w of the composition, nitrapyrin is present in an amount of from about 10% to about 20% w/w of the composition, adipic acid and polyanionic T5 polymer is present in an amount of from about 8% to about 12% w/w, and Agnique® AMD 3L is present in an amount of from about 63% to about 81.5% w/w of the composition.

36. The composition of embodiments 26, 27, 28, 30 and 32, wherein thiram is present in an amount of from about 0.5 to about 5% w/w of the composition, nitrapyrin is present in an amount of from about 10% to about 20% w/w of the composition, adipic acid and polyanionic T5 polymer is present in an amount of from about 5% to about 9% w/w, and Agnique® AMD 3L is present in an amount of from about 66% to about 84.5% w/w of the composition.

37. An agricultural composition comprising an agricultural product and the composition of any above embodiment, wherein the agricultural product is selected from the group consisting of a fertilizer, agriculturally active compounds, seed, urease inhibitors, pesticides, herbicides, insecticides, nitrification inhibitors, and a combination thereof.

38. A formulation comprising the composition of any above embodiment and one or more co-formulant(s) selected from solvents, surface active ingredients, carriers, wetting agents, emulsifiers, anti-foaming agents, preservatives and dyes.

39. A method of inhibiting nitrification in a soil, comprising contacting an effective amount of a composition of any above embodiment or an agricultural composition of embodiment 37 with the soil.

40. The method of embodiment 39, wherein nitrification is inhibited by at least 50%.

41. The method of embodiments 39 and 40, wherein nitrification is inhibited by at least 10% more compared to nitrification inhibitor containing compositions with no fungicide.

42. The method of embodiments 39, 40, and 41, wherein the effective amount of the composition comprises a synergistically effective amount of fungicide and nitrification inhibitor such that nitrification is reduced by at least 10% more compared to the sum of the individual nitrification inhibition of the fungicide and the nitrification inhibitor by itself.

### EXAMPLES

It should be understood that the following Examples are provided by way of illustration only and nothing therein should be taken as a limiting.

The following test formulations were prepared and formulations 2-4 were used in Examples 1 and 2, which are described in more detail below:

### Formulation 1 (Form.1)

| | |
|---|---|
| T5 tetrapolymer, as synthesized, low Na salt | 1.07% |
| adipic acid | 6.72% |
| nitrapyrin | 25.00% |
| Agnique AMD 3L | 67.21% |
| | 100.00% |

### Formulation 2 (Form.2)

| | |
|---|---|
| T5 tetrapolymer, as synthesized, low Na salt | 1.20% |
| adipic acid | 8.90% |
| nitrapyrin | 28.00% |
| Agnique AMD 3L | 61.90% |
| | 100.00% |

### Formulation 3 (Form.3)

| | |
|---|---|
| T5 tetrapolymer, as synthesized, low Na salt | 1.20% |
| adipic acid | 8.90% |
| nitrapyrin | 28.00% |
| Rhodiasolv Polarclean | 61.90% |
| | 100.00% |

### Formulation 4 (Form.4)

| | |
|---|---|
| adipic acid | 8.90% |
| nitrapyrin | 28.00% |
| Rhodiasolv Polarclean | 63.10% |
| | 100.00% |

### Example 1: Inhibition Measurement of Nitrosomonas europaea with Various Test Formulations and Test Compounds

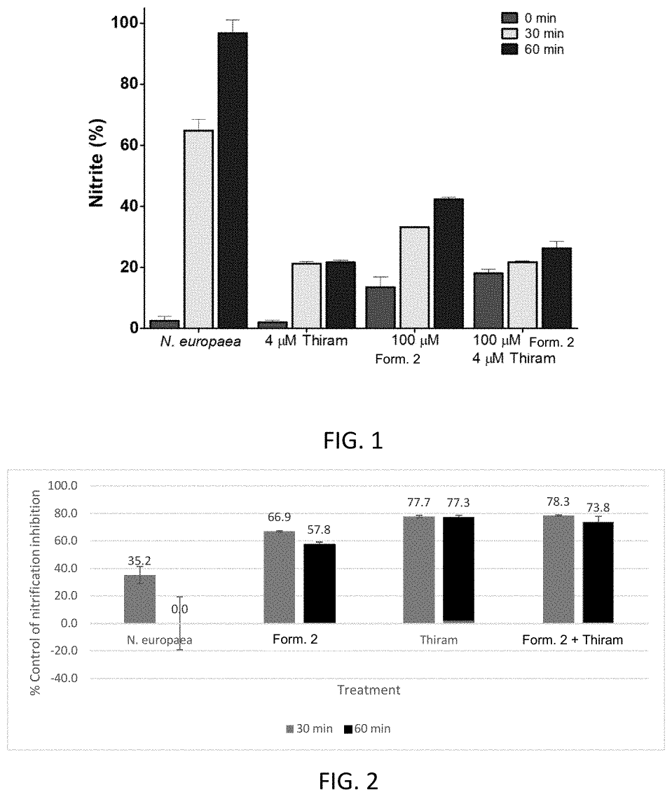

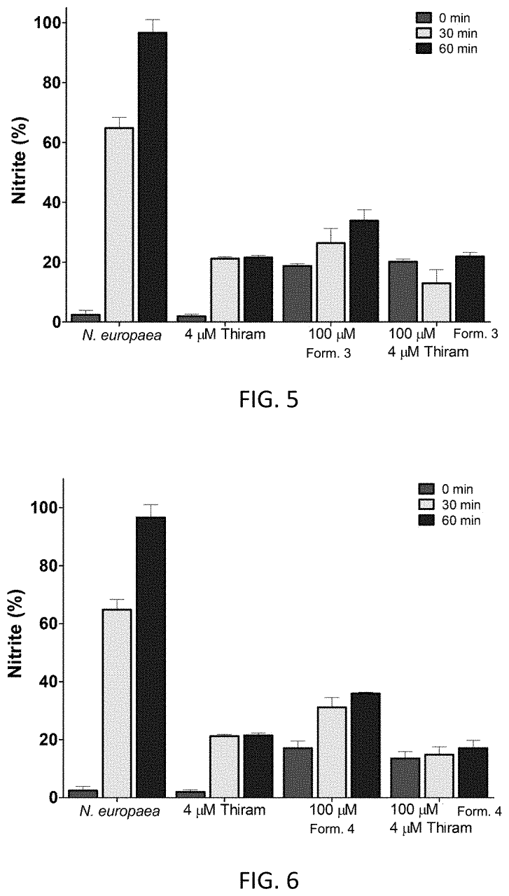

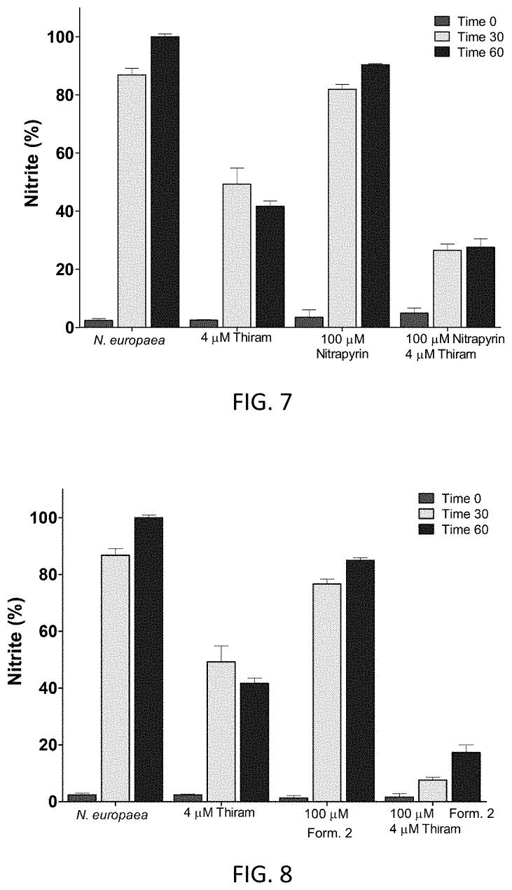

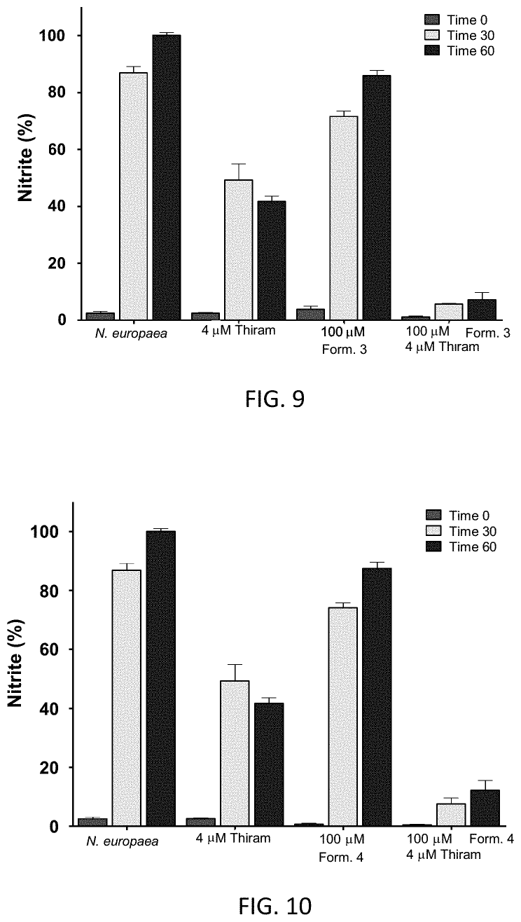

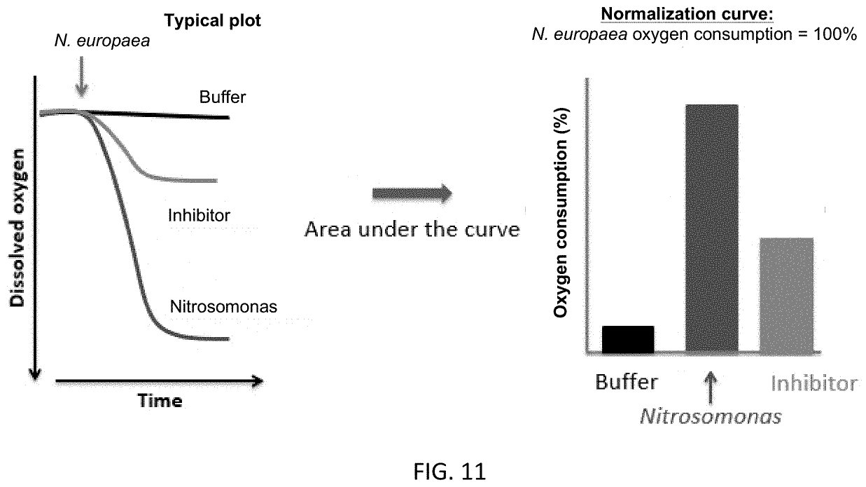

1.5 L of cell culture suspension containing Nitrosomonas europaea (N. europaea) bacteria (ATCC #19718) was resuspended into a phosphate buffer (0.1M NaPB, 2 mM Mg SO₄, pH of 7.5). The amount of N. europaea protein was quantified using a Biuret assay. A sample of the cell culture suspension containing about 0.3 mg/mL, 0.25 mg/mL, or 0.5 mg/mL of N. europaea protein was incubated with 50 μL of (NH₄)₂SO₄ in a total reaction volume of 5 mL. The test measured inhibition for treatment rates of 4 μM thiram, 100 μM nitrapyrin, 100 μM of formulation 2 (form.2), formulation 3 (form.3), formulation 4 (form.4) and 100 μM of formulation 2 (form.2) plus 4 μM thiram, 100 μM of formulation 3 (form.3) plus 4 μM thiram and 100 μM of formulation 4 (form.4) plus 4 μM thiram; an untreated N. europaea assay served as the control. At time points 0, 30, and 60 minutes post addition of (NH₄)₂SO₄, an aliquot of 500 μL was removed from the reaction mixture and was incubated for 30 minutes with 500 μL of Griess Reagent in the dark followed by measuring the absorbance at 548 nm for the presence or absence of nitrite. The percent of nitrification inhibition was calculated based on the relative percentage of nitrite measurement against the zero inhibitor control measurement (see FIGS. 2-4 showing the percent control of nitrification inhibition). Results of the nitrite measurements of the N. europaea containing cell suspension in the presence or absence of test formulations and/or test compounds are shown in FIGS. 1 and 5-11.

A Colby Analysis of the data shown in FIGS. 2-4 was carried out to predict the expected amount of synergism of various compositions containing mixtures of test compounds. In this Colby Analysis, when the Observed value is greater than the Expected value, a synergistic effect is present. For example, Table 1 below shows the Colby Analysis of the data obtained in FIG. 2 of formulation 2 (form.2) and thiram alone or in combination, where a synergistic effect is observed.

TABLE 1

| | 30 min | | | | |
|---|---|---|---|---|---|
| | | | form.2 + | form. 2 + | |
| | form.2 | Thiram | Thiram | Thiram | |
| | alone | alone | (Expected) | (Observed) | Synergy? |
| % control | 66.9 ± 0.5 | 77.7 ± 1.0 | 60.8 | 78.3 ± 0.6 | Yes |
| | 60 min | | | | |
| | | | form.2 + | form.2 + | |
| | form.2 | Thiram | Thiram | Thiram | |
| | alone | alone | (Expected) | (Observed) | Synergy? |
| % control | 57.8 ± 1.3 | 77.3 ± 1.2 | 57.1 | 73.8 ± 4.0 | Yes |

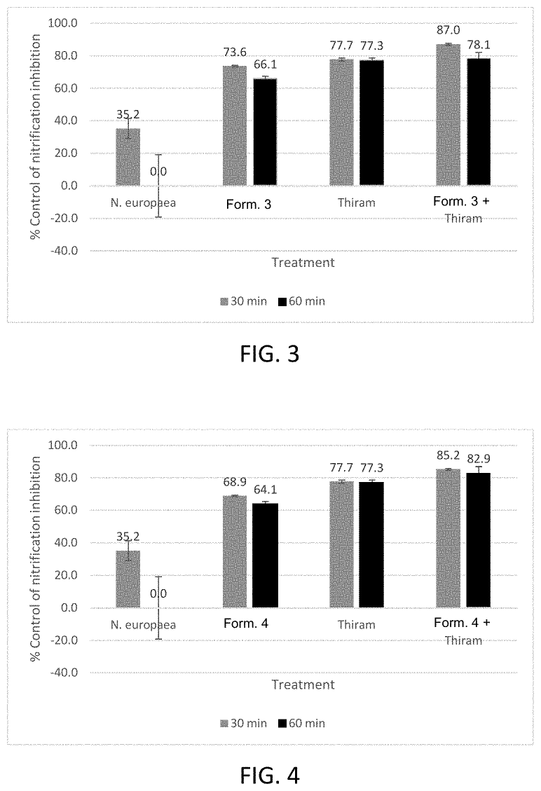

The next example was the Colby Analysis that was carried out to predict the expected amount of synergism formulation 3 (form.3) and thiram alone or in combination as is shown in Table 2 below which is based on the data obtained in FIG. 3.

TABLE 2

| | 30 min | | | | |
|---|---|---|---|---|---|
| | | | form.3 + | form.3 + | |
| | form.3 | Thiram | Thiram | Thiram | |
| | alone | alone | (Expected) | (Observed) | Synergy? |
| % control | 73.6 ± 8.4 | 77.7 ± 1.0 | 67.6 | 87.0 ± 7.9 | Yes |
| | 60 min | | | | |
| | | | form.3+ | form.3+ | |
| | form.3 | Thiram | Thiram | Thiram | |
| | alone | alone | (Expected) | (Observed) | Synergy? |
| % control | 66.1 ± 6.3 | 77.3 ± 1.2 | 60.4 | 78.1 ± 2.5 | Yes |

The last example was the Colby Analysis that was carried out to predict the expected amount of synergism formulation 4 (form.4) and thiram alone or in combination as is shown in Table 3 below based on the data obtained in FIG. 4.

TABLE 3

| | 30 min | | | | |
|---|---|---|---|---|---|
| | | | form.4 + | form.4 + | |
| | form.4 | Thiram | Thiram | Thiram | |
| | alone | alone | (Expected) | (Observed) | Synergy? |
| % control | 68.9 ± 5.9 | 77.7 ± 1.0 | 66.2 | 85.2 ± 4.8 | Yes |
| | 60 min | | | | |
| | | | form.4 + | form.4 + | |
| | form.4 | Thiram | Thiram | Thiram | |
| | alone | alone | (Expected) | (Observed) | Synergy? |
| % control | 64.1 ± 0.7 | 77.3 ± 1.2 | 64.1 | 82.9 ± 4.7 | Yes |

Note that percent control on nitrification inhibition in FIGS. 2-4 was calculated based on the relative percentage of nitrite measurement against the measurement without any test compounds. In all cases, the percent control of nitrification inhibitor of the mixture was higher than the percent control of nitrification of thiram and each formulation by itself at the 30 min and 60 min time point. In all cases, the observed synergism value was higher than the expected (calculated) value (see Tables 1-3 above).

### Example 2: Measurements of the Oxygen (02) Uptake of N. europaea in the Presence and Absence of Various Test Formulations and Test Compounds

1.5 L of cell culture suspension containing N. europaea bacteria (ATCC #19718) was resuspended into a phosphate buffer (0.1M NaPB, 2 mM Mg SO₄, pH of 7.5). The amount of N. europaea protein was quantified using a Biuret assay.

To a buffer solution containing 10 μM of (NH₄)₂SO₄ in in a total reaction volume of 5 mL was added 0.25 mg/mL of the N. europaea containing cell suspension. The N. europaea protein content varied (e.g., 0.25 mg/mL, 0.3 mg/mL or 0.5 mg/mL total protein). Measurements of O₂ present in the reaction medium were taken immediately after the addition of the cell suspension to the buffer solution for and were taken continuously over a certain time period.

Test compounds and formulations included 4 μM thiram, 100 μM nitrapyrin, 100 μM of formulation 2, 100 μM of formulation 3, 100 μM of formulation 4, 100 μM of formulation 2 plus 4 μM thiram, 100 μM of formulation 3 plus 4 μM thiram; and 100 μM of formulation 4 plus 4 μM, and thiram, untreated N. europaea assay served as the control.

Results are typically plotted as a function of measured oxygen (i.e., the amount of dissolved oxygen) in solution over time to generate a inhibition curve (FIG. 11). Measurements of the area under the inhibition curve can provide a bar chart showing the oxygen consumption of N. europaea of the entire testing period.

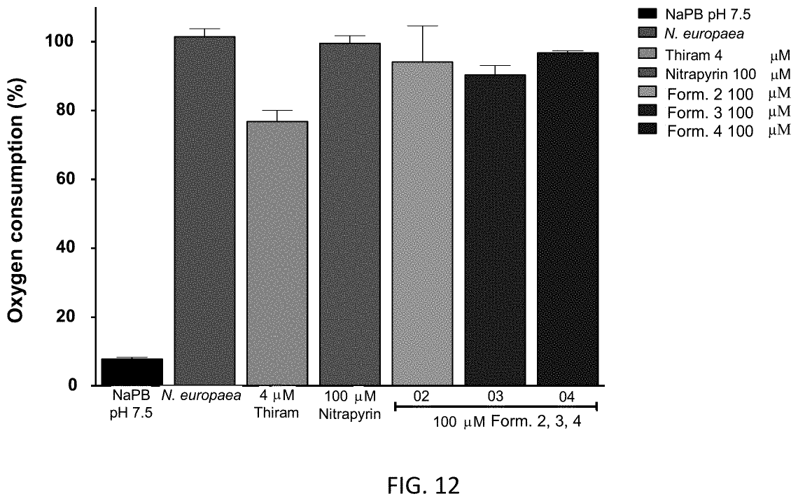

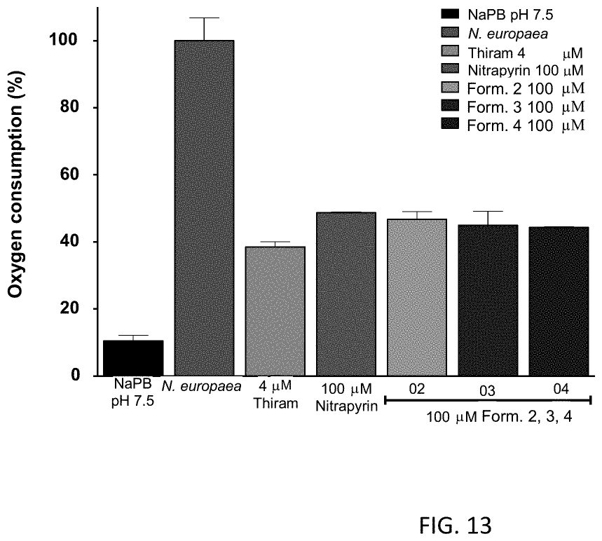

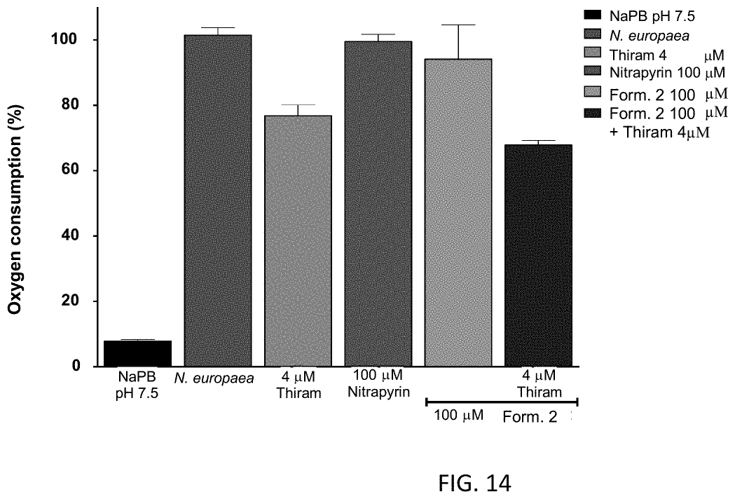

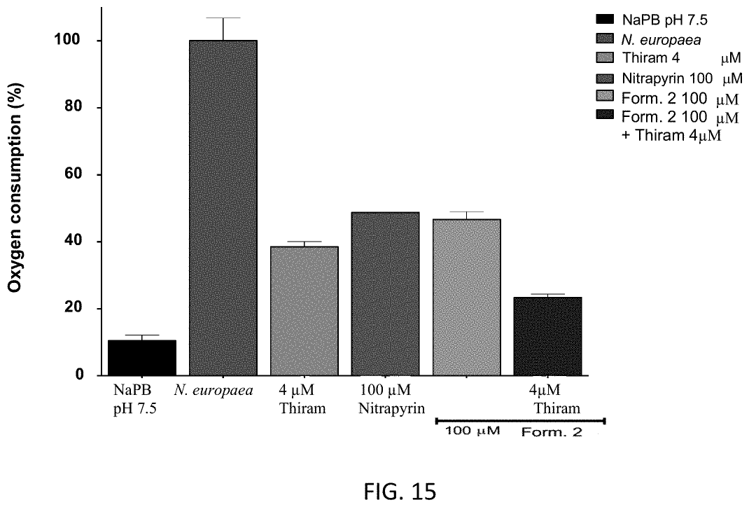

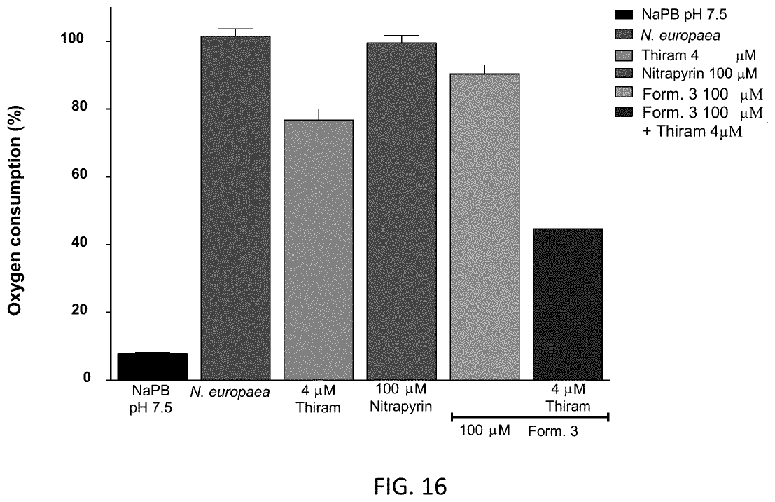

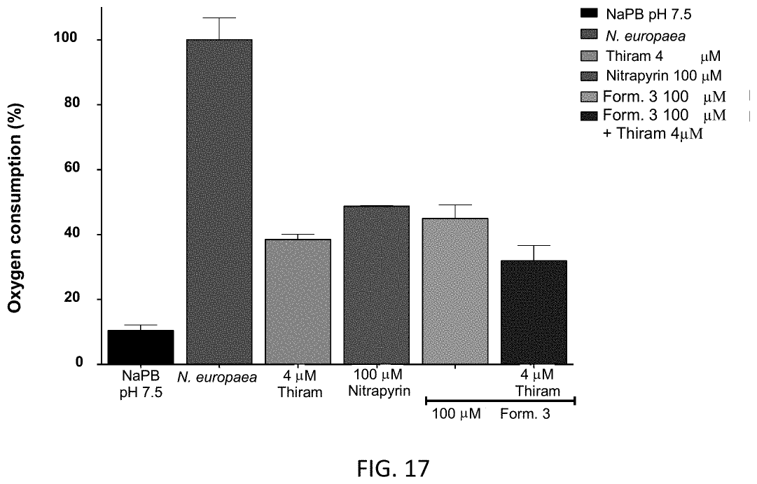

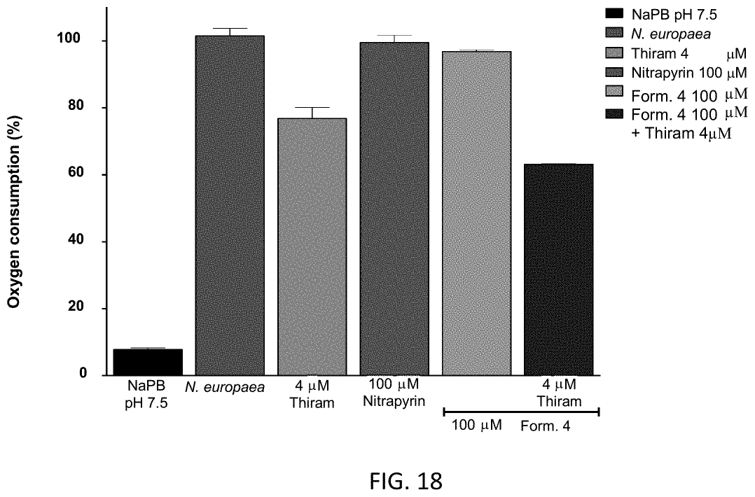

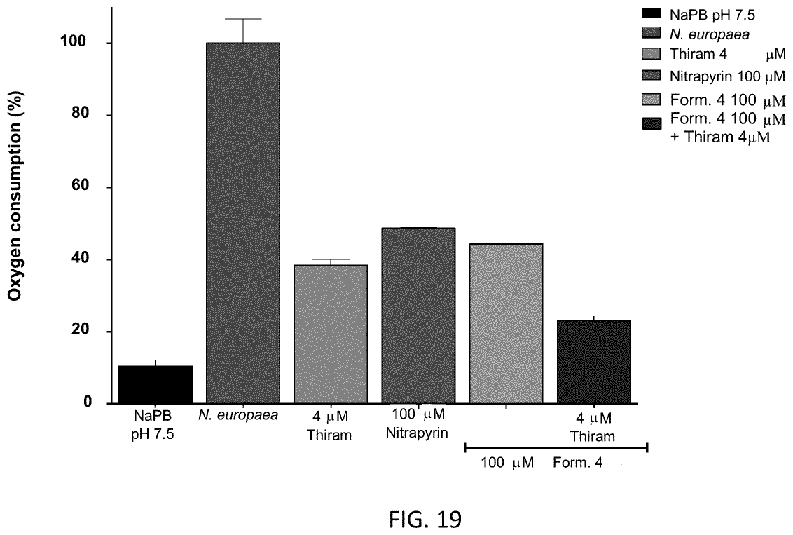

As such, results are shown in FIGS. 12-19. Note that in FIG. 12, thiram 4 μM was taken as a standard curve. In this case, the oxygen consumption was inhibited in 20% by thiram, whereas nitrapyrin and all test formulations at 100 μM did not inhibit oxygen consumption by N. europaea.

All technical and scientific terms used herein have the same meaning. Efforts have been made to ensure accuracy with respect to numbers used (e.g., amounts, temperature, etc.) but some experimental errors and deviations should be accounted for.

Many modifications and other embodiments set forth herein will come to mind to one skilled in the art to which this subject matter pertains, having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

We claim:

1. A composition comprising:
a fungicide selected from amide-based fungicides, dithiocarbamate-based fungicides, oxazole-containing fungicides, phosphoric acid-derived fungicides, and a combination thereof;
a nitrification inhibitor selected from S-containing compounds, cyano-containing compounds, N-heterocylic-containing compounds, and a combination thereof; and
a polyanion.

2. The composition of claim 1, wherein the fungicide is an amide-based fungicide selected from acylalanine fungicides (acylamino acid), anilide fungicide, benzanilide fungicide, and a combination thereof.

3. The composition of claim 2, wherein the amide-based fungicide is:
(a) an acylalanine (acylamino acid) fungicide selected from benalaxyl, benalaxyl-M, furalaxyl, metalaxyl, metalaxyl-M, and a combination thereof; or
(b) an anilide fungicide selected from boscalid, carboxin, fenhexamid, fluxapyroxad, isotianil, metsulfovax, ofurace, oxycarboxin, penflufen, pyracarbolid, pyraziflumid, sedaxane, thifluzamide, tiadinil, vanguard, benodanil, flutolanil, mebenil, mepronil, salicylanilide, tecloftalam, fenfuram, furcabinil, methfuroxam, and a combination thereof.

4. (canceled)

5. The composition of claim 1, wherein the fungicide is a dithiocarbamate-based fungicide selected from
(a) an ethylene-(bis)-dithiocarbamate (EBDC) selected from mancozeb, maneb, metiram, propineb, zineb, amobam, and a combination thereof; and/or
(b) a dimethyldithiocarbamate (DMDTC) selected from Na-dimethyl-dithiocarbamate, nabam, ziram, ferbam, thiram, asomate, azithiram, carbamorph, disulfiram, tecoram, urbacide, and a combination thereof; and/or
(c) monomethylthiocarbamate (MMDTC) metam sodium.

6. The composition of claim 1, wherein the fungicide is selected from:
(a) an oxazole-containing fungicide selected from famoxadone (3-anilino-5-methyl-5-(4-phenoxyphenyl)-1,3-oxazolidine-2,4-dione), oxadixyl, vinclozolin, myclozolin, dichlozoline, chlozolinate, drazoloxon, fluoxapiprolin, hymexazol, metzoloxon, myclozolin, oxathiapiprolin, pyrisoxazole, and a combination thereof; or
(b) a phosphite-containing fungicide selected from potassium phosphite (mono-, di-), sodium phosphite (mono-, di-), ammonium phosphite (mono-, di-), and a combination thereof; or
(c) a phosphonate-containing fungicide selected from potassium phosphite (mono-, di-), sodium phosphite (mono-, di-), ammonium phosphite (mono-, di-), and a combination thereof; or
(d) a phosphoric acid-containing fungicides in a salt form selected from potassium, calcium, sodium, cesium, magnesium, and/or ammonium salt;
and any combination thereof.

7. (canceled)

8. (canceled)

9. (canceled)

10. The composition of claim 1, wherein the nitrification inhibitor is selected from:
(a) an S-containing compound selected from ammoniumthiosulfate (ATU), 1-amino-2-thiourea (ASU), 2-mercapto-benzothiazole (MBT), 2,4-triazol thiourea (TU), 2-sulfanilamidothiazole (ST), 5-ethoxy-3-trichloromethyl-1,2,4-thiodiazole (terrazole), thiophosphoryl triamide; or
(b) a cyano-containing compound selected from 2-cyano-1-((4-oxo-1,3,5-triazinan-1-yl)methyl)guanidine,1-((2-cyanoguanidino)methyl)urea, 2-cyano-1-((2-cyanoguanidino)methyl)guanidine, dicyandiamide (DCD), pronitridine; or
(c) a N-heterocylic compound selected from 2-(3,4-dimethyl-1H-pyrazol-1-yl)succinic acid (DMPSA1), 2-(4,5-dimethyl-1H-pyrazol-1-yl)succinic acid (DMPSA2), 3,4-dimethyl pyrazolium salts, 2,4-triazole (TZ), 4-chloro-3-methylpyrazole (CIMP), N-((3(5)-methyl-1H-pyrazole-1-yl)methyl)acetamide, N-((3 (5)-methyl-1H-pyrazole-1-yl)methyl)formamide, N-((3(5),4-dimethylpyrazole-1-yl) methyl)formamide, N-((4-chloro-3 (5)-methyl-pyrazole-1-yl)methyl)formamide, 2-chloro-6-(trichloromethyl)-pyridine (nitrapyrin), 3,4-dimethyl pyrazole phosphate (DMPP), 4,5-dimethyl pyrazole phosphate (ENTEC), 3,4-dimethylpyrazole, 4,5-dimethylpyrazole (DMP), 4-amino-1,2,4-triazole hydrochloride (ATC), and 2-amino-4-chloro-6-methylpyrimidine (AM);
and any combination thereof.

11. (canceled)

12. (canceled)

13. The composition of claim 1, wherein the nitrification inhibitor is selected from nitrapyrin, DCD, DMPP, pronitridine, and salts and/or combinations thereof; and the fungicide is selected from metalaxyl, metalaxyl-M, mancozeb, ziram, zineb, thiram, and a combination thereof.

14. The composition of claim 1, wherein the fungicide and nitrification inhibitor are present in a synergistically effective amount.

15. (canceled)

16. The composition of claim 1, wherein the polyanion comprises a non-polymeric polyanion, a polyanionic polymer, or a combination thereof.

17. The composition of claim 16, wherein the non-polymeric polyanion comprises a di-, tri-, tetra-, penta-, hexa-, hepta-, octa-, nona-, or deca-carboxyl, a di-, tri-, tetra-, penta-, hexa-, hepta-, octa-, nona-, or deca-sulfonate, or a di-, tri-, tetra-, penta-, hexa-, hepta-, octa-, nona-, or deca-phosphonate.

18. (canceled)

19. (canceled)

20. The composition of claim 16, wherein the polyanionic polymer comprises a random copolymer having at least two repeat units including at least one each of type B and type C repeat unites, and optionally one or more different type G repeat units, wherein:
a) the type B repeat units are independently selected from the group consisting of repeat units derived from substituted and unsubstituted monomers of maleic acid, maleic anhydride, fumaric acid, fumaric anhydride, mesaconic acid, mesaconic, mixtures of the foregoing, and any isomers, esters, acid chlorides, and partial or complete salts of any of the foregoing, wherein type B repeat units may be substituted with one or more C₁-C₆ straight or branched chain alkyl groups substantially free of ring structures and halo atoms, and wherein the salts have salt-forming cations selected from the group consisting of metals, amines, and mixtures thereof;
b) the type C repeat units selected from the group consisting of repeat units derived from substituted or unsubstituted monomers of itaconic acid, itaconic anhydride, and any isomers, esters, and the partial or complete salts of any of the foregoing, and mixtures of any of the foregoing, wherein the type C repeat units may be substituted with one or more C₁-C₆ straight or branched chain alkyl groups substantially free of ring structures and halo atoms, and wherein the salts have salt-forming cations selected from the group consisting of metals, amines, and mixtures thereof; and
c) the type G repeat units selected from the group consisting of repeat units derived from substituted or unsubstituted sulfonated monomers possessing at least one carbon-carbon double bond and at least one sulfonate group and which are substantially free of aromatic rings and amide groups, and any isomers, and the partial or complete salts of any of the foregoing, and mixtures of any of the foregoing, wherein type G repeat units may be substituted with one or more C₁-C₆ straight or branched chain alkyl groups substantially free of ring structures and halo atoms, and wherein the salts of the type G repeat units have salt-forming cations selected from the group consisting of metals, amines, and mixtures thereof,
and wherein at least about 90 mole percent of the repeat units therein are selected from the group consisting of type B, C, and G repeat units, and mixtures thereof, and, wherein the polyanionic polymer contains no more than about 10 mole percent of any of (i) non-carboxylate olefin repeat units, (ii) ether repeat units, and (iii) non-sulfonated monocarboxylic repeat units.

21. The composition of claim 20, wherein
(a) the polyanionic polymer consists of one type B repeat unit derived from maleic acid, one type C repeat unit derived from itaconic acid, and two type G repeat units respectively derived from methallylsulfonic acid and allylsulfonic acid; and/or
(b) the polyanionic polymer is a copolymer consisting of maleic and itaconic repeat units; and/or
(c) the polyanion comprises adipic acid and a T5 polyanionic polymer having a repeat unit molar composition of 45 mole percent maleic repeat units, 50 mole percent itaconic repeat units, 4 mole percent methallylsulfonate repeat units, and 1 mole percent allylsulfonate repeat units.

22. (canceled)

23. (canceled)

24. The composition of claim 1, wherein the nitrification inhibitor is complexed with the polyanion.

25. The composition of claim 1, further comprising an organic solvent.

26. The composition of claim 25, wherein the organic solvent is selected from Agnique® AMD 810, Agnique® AMD 3L, Rhodiasolv® ADMA 10, Rhodiasolv® ADMA 810, and/or Rhodiasolv® Polarclean, and a combination thereof.

27. (canceled)

28. The composition of claim 25, comprising a polyanionic polymer having a repeat unit molar composition of 45 mole percent maleic repeat units, 50 mole percent itaconic repeat units, 4 mole percent methallylsulfonate repeat units, and 1 mole percent allylsulfonate repeat units.

29. The composition of claim 25, wherein the fungicide is present in an amount of from about 0.01% to about 45% w/w of the composition, the nitrification inhibitor is present in an amount of from about 0.01 to about 30% w/w of the composition, the polyanion is present in an amount of from about 0.01% to about 15% w/w of the composition, and the organic solvent is present in an amount of from about 10% to about 99.97% w/w of the composition.

30. (canceled)

31. (canceled)

32. (canceled)

33. (canceled)

34. (canceled)

35. (canceled)

36. An agricultural composition comprising an agricultural product and the composition of claim 1, wherein the agricultural product is selected from the group consisting of a fertilizer, agriculturally active compounds, seed, urease inhibitors, pesticides, herbicides, insecticides, nitrification inhibitors, and a combination thereof.

37. A formulation comprising the composition of claim 1 and one or more co-formulant(s) selected from solvents, surface active ingredients, carriers, wetting agents, emulsifiers, anti-foaming agents, preservatives and dyes.

38. A method of inhibiting nitrification in a soil, comprising contacting an effective amount of a composition of claim 1 with the soil.

39. (canceled)

40. (canceled)

41. (canceled)
